(19) United States
(12) Patent Application Publication
(10) Pub. No.: US 2012/0026954 A1
(43) Pub. Date: Feb. 2, 2012

(54) RESOURCE ALLOCATION SIGNALING OF WIRELESS COMMUNICATION NETWORKS

(75) Inventors: Lei Wang, San Diego, CA (US); Ronald G. Murias, Calgary (CA)

(73) Assignee: INTERDIGITAL PATENT HOLDINGS, INC., Wilmington, DE (US)

(21) Appl. No.: 13/177,351

(22) Filed: Jul. 6, 2011

Related U.S. Application Data
(60) Provisional application No. 61/363,068, filed on Jul. 9, 2010.

(51) Int. Cl. H04W 72/04

(52) U.S. Cl. 370/329

(57) ABSTRACT

A method and apparatus addresses resource allocation granularity issues for encoding efficiency of resource allocation signaling in assignment information elements (IEs).

### CROSS REFERENCE TO RELATED APPLICATIONS

This application claims the benefit of U.S. provisional application No. 61/363,068 filed on Jul. 9, 2010, the contents of which is hereby incorporated by reference herein.

### BACKGROUND

In an advanced broadband wireless system, an air link refers to a communication channel between the BS (Base Station) and an MS (Mobile Station) using the air as media. A scheduling-based media access control (MAC) is used to manage/control the usage of the air link resources. With the scheduling-based MAC, the BS uses collected information about resource requirements to allocate air link resource for the MSs, where the resource allocations are specified in the control signal, called Advanced MAP (A-MAP) Information Elements (IEs). An A-MAP IE specifies who, when, where, and how to transmit/receive. The when and where specifies the air link resources in an orthogonal frequency division multiple access (OFDMA) two-dimensional frame structure in both time-domain and frequency-domain.

### SUMMARY

A method for resource allocation in assignment of information elements (IEs) comprises defining sets of selective starting locations (L) and allocation sizes (S) in combinations (L,S) for resource allocations, based on a predetermined total number of available logical resource units (LRUs) and valid resource allocations; and defining a mapping of a resource index to each combination (L,S), wherein the location size S is a number of LRUs.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2A is an example of a downlink (DL) physical (PHY) structure with frequency partitions and different types of logical resource units (LRUs);

FIG. 2B shows an example mapping for the PHY structure shown in FIG. 2A; and

FIG. 3 is an example of control channel allocations.

### DETAILED DESCRIPTION

Resource allocation constraints may be used to reduce the number of valid allocations so that the required signaling information field in the assignment A-MAP IEs may be efficiently coded by only signaling the valid allocations. For example, one allocation may not cross two different LRU types (e.g., miniband LRU (NLRU), subband LRU (SLRU) or distributed LRU (DLRU), but not mixed), and/or one allocation may be contained in the same frequency partition and may not span multiple frequency partitions.

The A-MAP IE mapping may be constrained and reduced by not mapping to resource locations for resources occupied by the downlink and uplink control channels in a subframe.

The assignable allocation sizes may be limited, the allocation starting position may be limited, or both the sizes and the starting locations may be limited to reduce the required RI (Resource Index) mapping.

Information regarding the maximum allocation size, the given STC_rate and the TTI_length may be used to derive the value range of the number of LRUs for an allocation so that the number of allocations that need to be signaled in the assignment A-MAP IEs may be effectively reduced.

The size of RI (Resource Index) may be extended by one or more additional bits that are reserved and unused, or by reshuffling some other fields of the current assignment A-MAP IE.

Additionally, other mechanisms may be used to support allocations of discrete LRUs.

These embodiments may be used independently or in any combination.

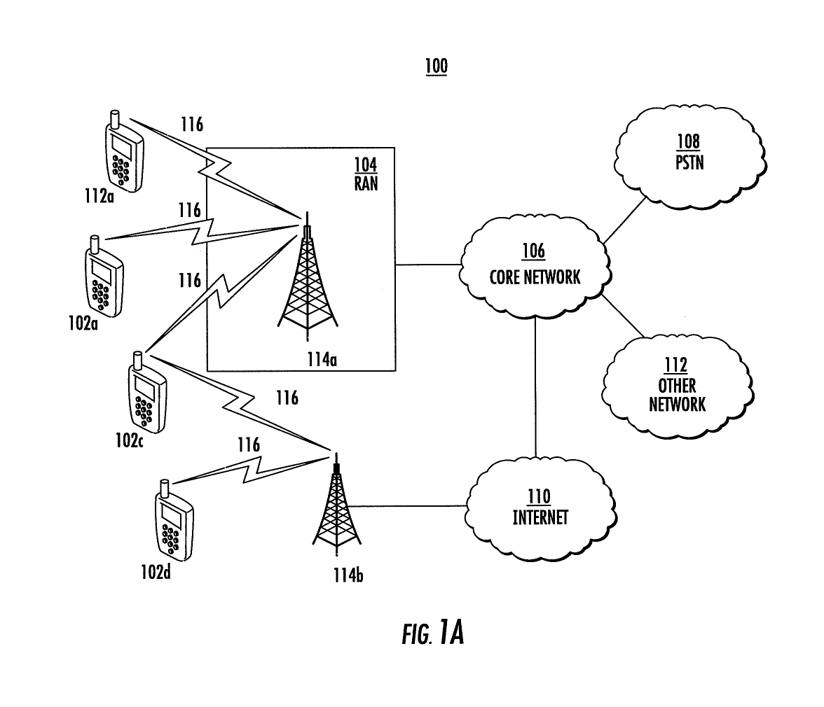

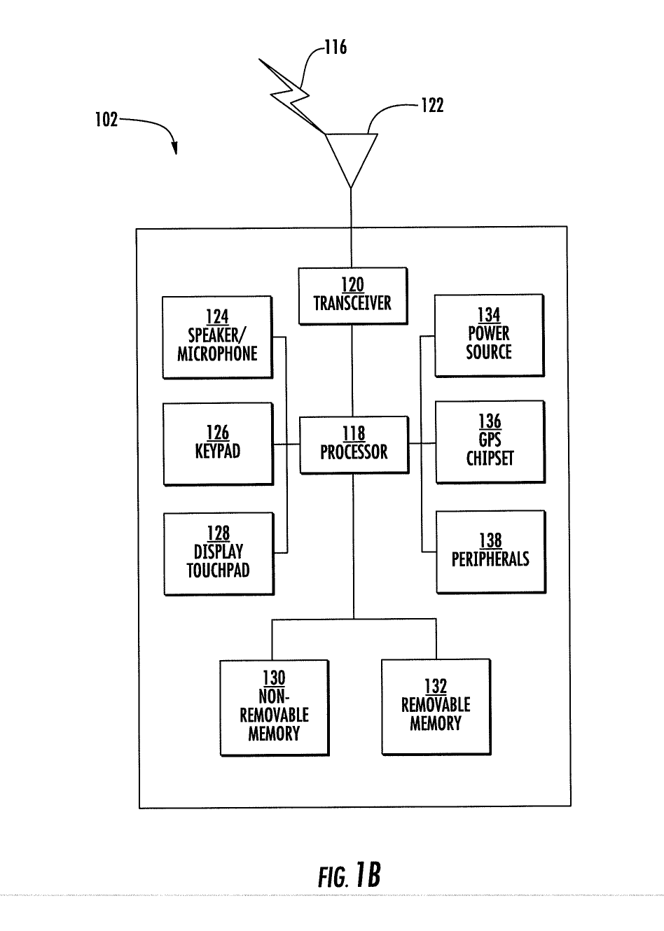

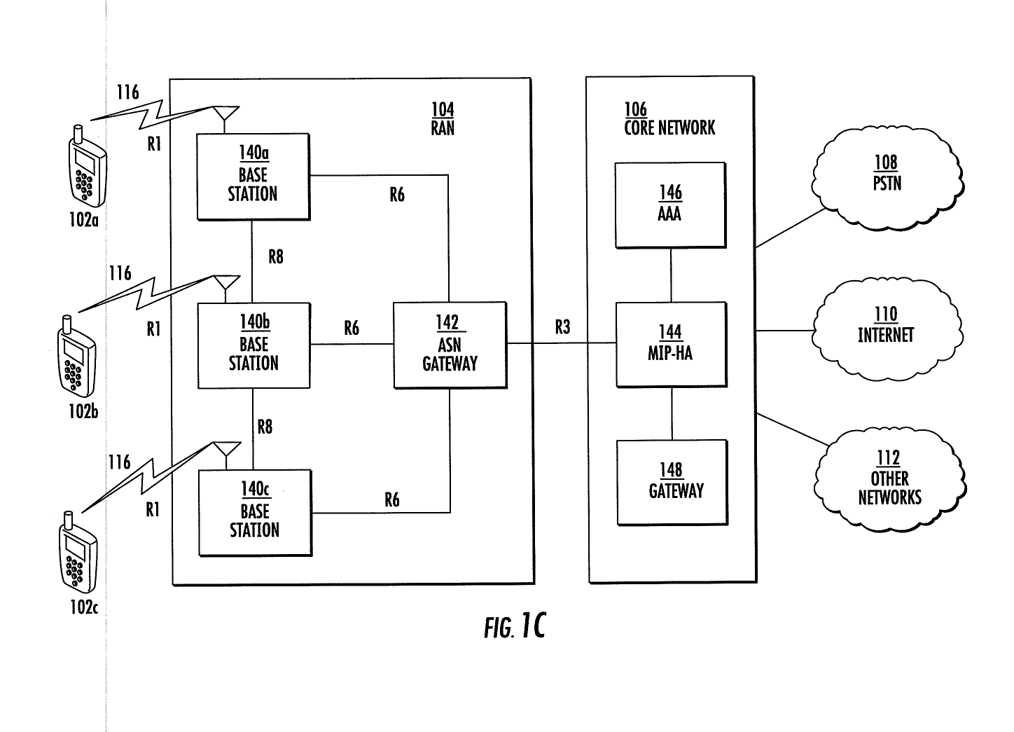

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, an advanced mobile station (MS), and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, an advanced base station (BS), and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, BS, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 1C, the RAN 104 may include base stations 140a, 140b, 140c, and an ASN gateway 142, though it will be appreciated that the RAN 104 may include any number of base stations and ASN gateways while remaining consistent with an embodiment. The base stations 140a, 140b, 140c may each be associated with a particular cell (not shown) in the RAN 104 and may each include one or more transceivers for communicating with the WTRUs 102a, 102b, 102c over the air interface 116. In one embodiment, the base stations 140a, 140b, 140c may implement MIMO technology. Thus, the base station 140a, for example, may use multiple antennas to transmit wireless signals to, and receive wireless signals from, the WTRU 102a. The base stations 140a, 140b, 140c may also provide mobility management functions, such as handoff triggering, tunnel establishment, radio resource management, traffic classification, quality of service (QoS) policy enforcement, and the like. The ASN gateway 142 may serve as a traffic aggregation point and may be responsible for paging, caching of subscriber profiles, routing to the core network 106, and the like. A scheduling-based MAC may be implemented within the base stations 140a, 140b, 140c and/or the ASN gateway 142 for execution of the resource mapping according to the methods described herein. The base stations, 140a, 140b, and 140c may provide the resource mapping descriptions/instructions for the subscribers, where the ASN gateway and/or other network entities may provide information to the BS to make the right resource allocation decisions.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 140a, 140b, 140c may be defined as an R8 reference point that includes protocols for facilitating WTRU handovers and the transfer of data between base stations. The communication link between the base stations 140a, 140b, 140c and the ASN gateway 215 may be defined as an R6 reference point. The R6 reference point may include protocols for facilitating mobility management based on mobility events associated with each of the WTRUs 102a, 102b, 100c.

As shown in FIG. 1C, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 144, an authentication, authorization, accounting (AAA) server 146, and a gateway 148. While each of the foregoing elements are depicted as part of the core network 106, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 144 may provide the WTRUs 102a, 102b, 102c with access to packet-switched networks, such as the Internet 110, to facilitate communications between the WTRUs 102a, 102b, 102c and IP-enabled devices. The AAA server 146 may be responsible for user authentication and for supporting user services. The gateway 148 may facilitate interworking with other networks. For example, the gateway 148 may provide the WTRUs 102a, 102b, 102c with access to circuit-switched networks, such as the PSTN 108, to facilitate communications between the WTRUs 102a, 102b, 102c and traditional land-line communications devices. In addition, the gateway 148 may provide the WTRUs 102a, 102b, 102c with access to the networks 112, which may include other wired or wireless networks that are owned and/or operated by other service providers.

Although not shown in FIG. 1C, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

With respect to the A-MAP information elements (IEs) used to specify downlink and uplink resource allocations, a 20 MHz channel may be specified having 96 logical resource units (LRUs), for a total number of 4656 possible allocations to be indexed. While this would require a 13-bit Resource Index (RI), one current specification calls for a smaller 11-bit RI, which cannot accommodate the full 4696 possible allocations. One solution is to compress the indexes by incrementing an allocation location index L and an allocation size index S which reduces the total number of indexes. The allocation location index L is denotes a starting location of the allocated LRUs, and the allocation size index S represents the number of allocated LRUs (i.e., an LRU allocation consists of S contiguous LRUs starting from the LRU with index L).

Examples of index L and index S that utilize an 11-bit RI, include the following: when 14<=5<=24, L may be incremented by 2 LRUs; when 28<=5<=48, L may be incremented by 4 LRUs; and when 56<=5<=88, L may be incremented by 8 LRUs. However, using these assignment granularities of 1, 2, 4, or 8 LRUs for index L, air link resources may be wasted when the required size does not fit exactly into one of the allowed sizes. For example, if the required size is 57 LRUs, which is not an allowed size, the next allowed size is 64, thus 7 extra LRUs are needed (i.e., 7/57=12.28% extra). In addition, the number of LRUs specified in the assignment IEs is for one subframe. The number of extra LRUs due to this allocation granularity issue may become much worse in the long transmission time interval (TTI) cases and/or the space time control (STC) case where STC_rate>1, because the allocation size is the product of STC_rate, long TTI factor, and the number of LRUs specified in the assignment IE.

Rate matching is the process where the number of bits to be transmitted is reduced to fit the allocated size. Typically, some redundant bits (generated by a forward error correction scheme) in the stream are removed to reduce the size of the block to be transmitted. When the rate-matching scheme is used, and the required number of LRUs is not an assignable size, the number of allocated LRUs may be either smaller or greater than the required number of LRUs. In this case, the offset may be as big as 4 LRUs (e.g., when the required number of LRUs is 60, and the two closest assignable sizes are 56 and 64). An offset of 4 LRUs is significant. The methods and apparatus described herein may improve the encoding efficiency of resource allocation signaling in the assignment IEs, and also improve the resource usage efficiency allocation granularity.

The downlink/uplink basic assignment A-MAP IE may apportion a single allocation of resources, comprising a set of contiguous LRUs in a downlink/uplink advanced air interface (AAI) subframe, where the allocated set of contiguous LRUs may be contained within the same frequency partition (i.e., the allocated set of contiguous LRUs may not span multiple frequency partitions). The allocated set of contiguous LRUs may be of the same type (e.g., DLRU, NLRU, or SLRU).

Using the same frequency partition and the same type of LRUs for resource allocation improves the resource allocation specification encodings, by elimination of invalid combinations of allocation starting points and allocation sizes.

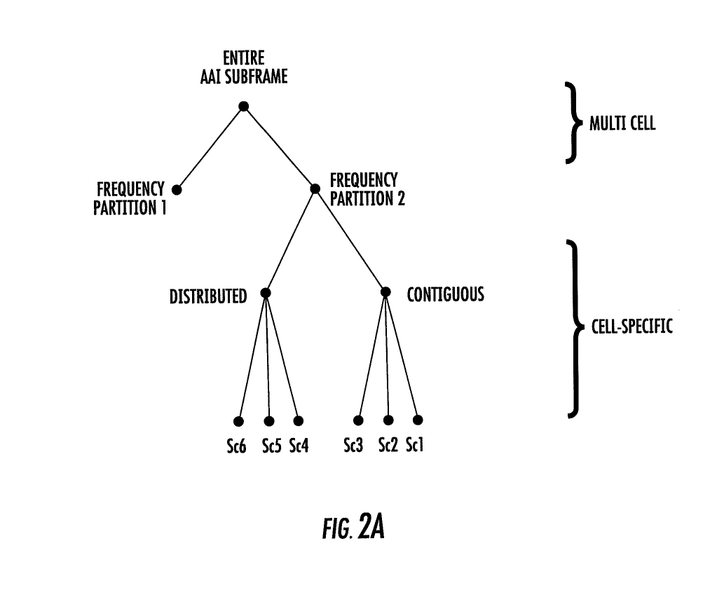

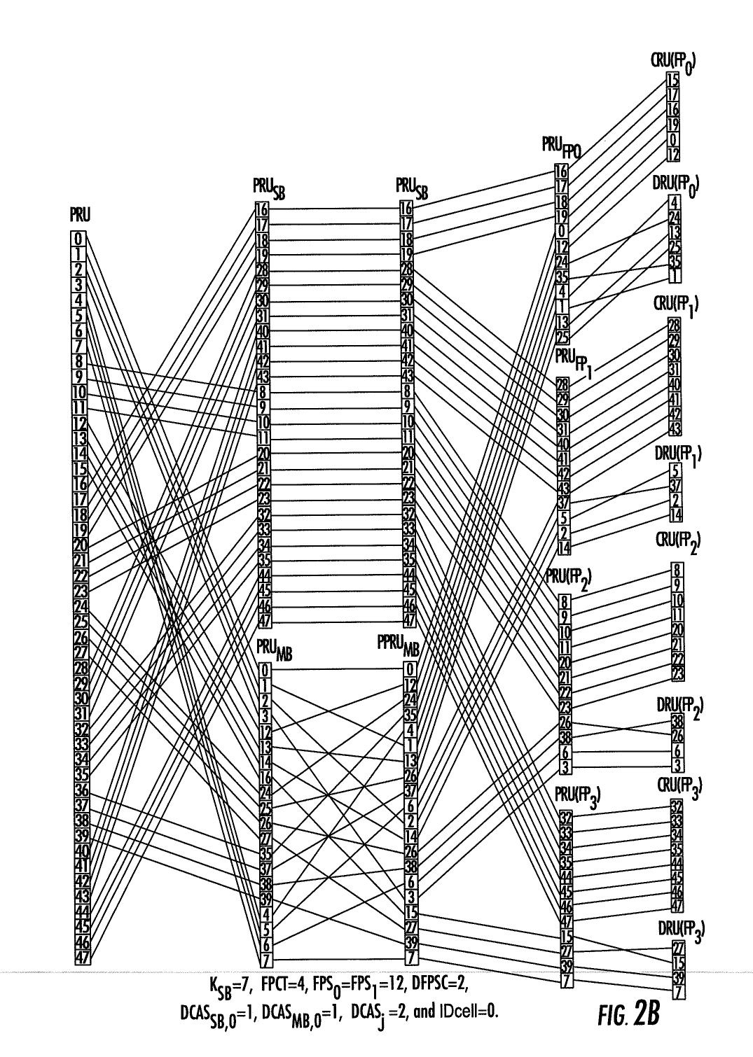

FIG. 2A shows an example of a downlink PHY structure based on a subframe divided into frequency partitions (multi-cell), each partition having a set of physical resource units (PRUs) across a total number of available OFDMA symbols. Each frequency partition can include contiguous (localized) and/or distributed PRUs (cell specific). The PRU is the basic physical unit for resource allocation having a number of consecutive subcarriers (SC1, SC2 . . . SCn) by a number of consecutive OFDMA symbols.

FIG. 2B shows an example of resource mapping from PRUs to LRUs, which includes subband partitioning, miniband partitioning, and frequency partitioning. The PRUs are first partitioned by subbands PRUsB and minbands PRU_{MB}. As shown in FIG. 2, there are 7 subbands. A permutation on the minibands is performed based on the channel bandwidth, shown as PRU_{MB} to PPRU_{MB}, to ensure frequency diverse PRUs are allocated to each frequency partition. The subbands PRUsB and the minibands PRU_{MB} are then allocated to one or more frequency partitions, shown as PRU_{FP0} to PRU_{FP3}, according to a frequency partition count (FPCT). In this example, FPCT=4, as there are four frequency partitions. The allocation is also based on a defined frequency partition size (FPS) (e.g., FPS=12) as the number of PRUs allocated to the i-th frequency partition, along with the number of subbands allocated to the i-th frequency partition (e.g., downlink frequency partition subband count (DFPSC=2).

Finally, a cell-specific resource mapping may be performed that maps the frequency partitions to LRUs, which are divided into contiguous resource units (CRUs) and distributed resource units (DRUs). The CRUs include miniband CRUs (NRLUs) and subband CLUs (SRLUs). In the A-MAP assignment IEs, an ordered LRU list, LRU[1] to LRU[NMAX], may be used to specify an allocation, where the LRU list is specified by mapping the DRUs, NLRUs, and SLRUs in different frequency partitions in a certain order. For an example where there are four frequency partitions, the mapping order may be: FP0(DLRUs, NLRUs, SLRUs), FP1(DLRUs, NLRUs, SLRUs), FP2(DLRUs, NLRUs, SLRUs), and FP3(DLRUs, NLRUs, SLRUs).

When applying the constraints of same frequency partition and the same type of LRUs for a resource allocation, the number of valid allocations in a subframe may be significantly reduced for the PHY subframe structure with multiple frequency partitions and/or multiple types of LRUs. As an example, for the mapping shown in FIG. 2B, the number of valid allocations can be reduced to 172, when compared to 1186 valid allocations that would exist without applying the constraints of the same frequency and the same LRU type, which results in an 85.37% reduction. FIG. 2B shows 172 valid allocations, and 1186 possible combinations of (L, S). These numbers come from calculations for the combinations of starting location (L) and allocation size (S) shown in the following table.

TABLE 1
DL PHY with 10 MHz, 4 FRs, multiple
types of LRUs (DLRUs, SB-CRUs, and
MB-CRUs)

| Location | # of valid sizes | # of possible sizes |
|---|---|---|
| 1 | 4 | 48 |
| 2 | 3 | 47 |
| 3 | 2 | 46 |
| 4 | 1 | 45 |
| 5 | 2 | 44 |
| 6 | 1 | 43 |
| 7 | 6 | 42 |
| 8 | 5 | 41 |
| 9 | 4 | 40 |
| 10 | 3 | 39 |
| 11 | 2 | 38 |
| 12 | 1 | 37 |
| 13 | 8 | 36 |
| 14 | 7 | 35 |
| 15 | 6 | 34 |
| 16 | 5 | 33 |
| 17 | 4 | 32 |
| 18 | 3 | 31 |
| 19 | 2 | 30 |
| 20 | 1 | 29 |
| 21 | 4 | 28 |
| 22 | 3 | 27 |
| 23 | 2 | 26 |
| 24 | 1 | 25 |
| 25 | 8 | 24 |
| 26 | 7 | 23 |
| 27 | 6 | 22 |
| 28 | 5 | 21 |
| 29 | 4 | 20 |
| 30 | 3 | 19 |
| 21 | 2 | 28 |
| 32 | 1 | 17 |
| 33 | 4 | 16 |
| 34 | 3 | 15 |
| 35 | 2 | 14 |
| 36 | 1 | 13 |
| 37 | 8 | 12 |
| 38 | 7 | 11 |
| 39 | 6 | 10 |
| 40 | 5 | 9 |
| 41 | 4 | 8 |
| 42 | 3 | 7 |
| 43 | 2 | 6 |
| 44 | 1 | 5 |
| 45 | 4 | 4 |
| 46 | 3 | 3 |
| 47 | 2 | 2 |
| 48 | 1 | 1 |
| | 172 | 1186 |
| | valid allocations | all possible (L, S) |
| | in (L, S) | combinations |
| | combinations | |

This reduction may be useful in resolving the 11-bit RI index code deficit with respect to the maximum 4656 allocations in 20 MHz systems, requiring a 13-bit RI.

For each combination of system channel bandwidth (e.g., 5 MHz, 10 MHz, or 20 MH), frequency partitions, and LRU type compositions (such as the mapping shown in FIG. 2B), there exists a table entry in an RI table, which uses an 11-bit RI value as a table index, and each table entry includes corresponding index values (L,S), representing a valid allocation. The RI tables are used at both the WTRU 102 and the base station 114 to code and decode the assignment A-MAP IEs. Both the frequency partitioning and the LRU structure may be included in the system configuration information, which are either static or semi-static for a system deployment.

The downlink and uplink frequency partitions may be defined in a frame header, such as a Secondary Super Frame Header (S-SFH), by parameters Downlink Frequency Partition Configuration (DFPC) and Uplink Frequency Partition Configuration (UFPC), respectively. For both downlink and uplink, the number of defined frequency partitions varies with fast Fourier transform (FFT) sizes of the PHY system. For example, there may be n different frequency partition configurations for 2048-FFT, m configurations for 1024-FFT, and p configurations for 512-FFT, for both downlink and uplink.

The downlink/uplink LRU structures may also be defined in the S-SFH by parameters downlink/uplink Subband Allocation Count (DSAC/USAC), downlink/uplink Frequency Partition Subband Count (DFPSC/UFPSC), and downlink/uplink CRU Allocation Size (DCASi/UCASi). The number of different LRU structures also varies with the system FFT size. For example, for both downlink and uplink, there may be q valid subband allocations for 2048-FFT, r subband allocations for 1024-FFT, and s subband allocations for 512-FFT.

At least one of the following options are available for the above described resource mapping. Both the frequency partitioning and the LRU structure information may be included. Only the frequency partition information may be used. Only the LRU structure information may be used. Selecting either the frequency partition information and/or the LRU structure information only as needed (e.g., in 20 MHz bandwidth systems).

As an alternative method for reducing resource allocation with respect to the assignment A-MAP IEs, the uplink and downlink control channels may be pre-defined or configured to resources such that the assignment A-MAP IEs do not need to perform this mapping. The existence of the non-assignable LRUs occupied by the control channels in the allocation specification encoding design reduces the number of valid allocations in a subframe.

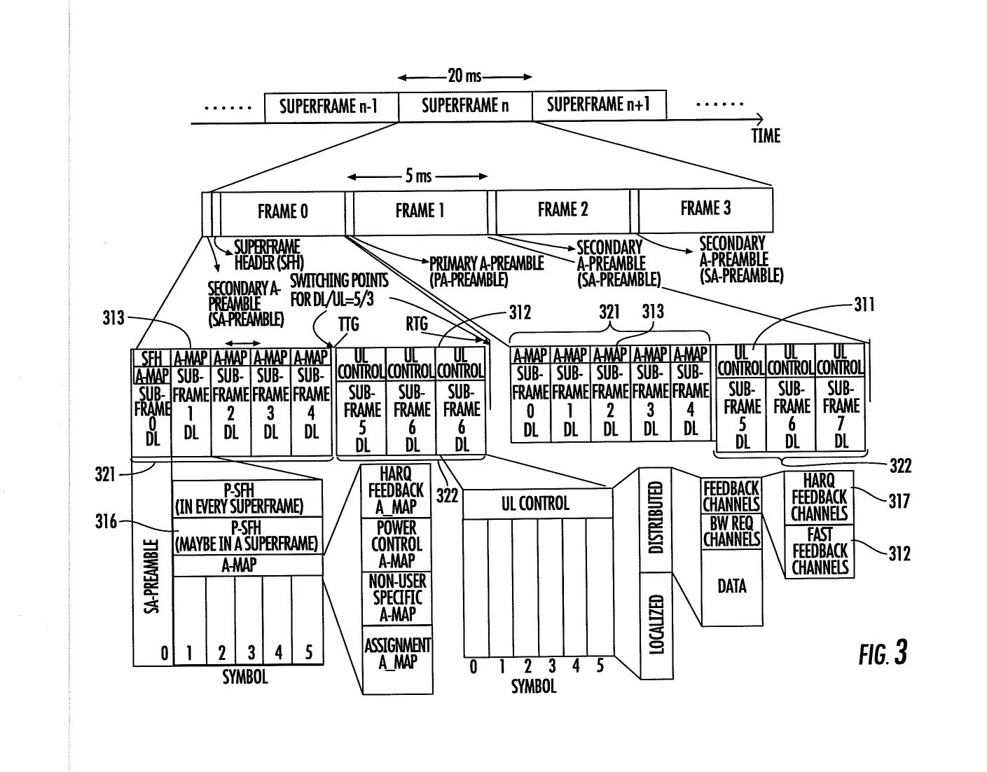

FIG. 3 shows an example of a frame structure with control channel allocations. As shown, for the downlink subframes 321, the A-MAP regions 313 may be present in all AAI subframes. For the uplink subframes 322, a hybrid automatic repeat request (HARQ) feedback region 317 may be present in all uplink subframes. The uplink control channels 311 may occupy the resources that are pre-defined or configured. In the uplink subframes 322, the number of DLRUs reserved for Feedback channels 312 may be specified by a field UL FEEDBACK SIZE in the secondary superframe header (S-SFH) 316. Thus, there is no need for the assignment A-MAP IEs to do the allocations for the uplink feedback channels 312, thus reducing the number of allocations that need to be signaled in the assignment A-MAP IEs. By knowing the size of the A-MAP region 313 (defined as L_{AMAP} LRUs) in a downlink subframe 321 and the size of uplink feedback channels 312 in an uplink subframe, the number of valid allocations for the assignment IEs to signal may be determined, and the mapping between the RI codes and valid allocations in terms of location and size indexes (L, S) may be defined, as previously described.

For example, if L_{AMAP}=6 LRUs in a 20 MHz channel bandwidth, excluding the control channel occupied resources, the number of allocations for the A-MAP IE is 4095 after eliminating the size of the uplink feedback channels. This is a significant reduction of the full 4656 possible allocations without excluding the control channel occupied resources.

The assumption of L_{AMAP}=6 LRUs may be conservative. The A-MAP modulation/coding selections are quadrature phase-shift keying (QPSK) ½, QPSK ¼, and QPSK ⅛. One LRU may be 18 subcarriers*6 symbols=108 tones, while typically there are 6 pilot tones. This gives 102 data bits for the QPSK ½, and 51 data bits for the QPSK ¼. On the other hand, an assignment A-MAP IE is typically 56 bits (i.e., 40 bits data plus 16 bits CRC). In addition to the assignment A-MAP IEs, the A-MAP region may also contain the HARQ feedback and power control IEs. Consider the number of data bits for an LRU carrier in the DL control channel, i.e., 51 bits for QPSK ¼, which is close to, but not enough, for one A-MAP IE. So, a DL control channel with 6 LRUs may accommodate 5 A-MAP IEs, i.e., specify 5 DL resource allocations. Further, a DL control channel may also carry other control information, e.g., HARQ feedback, power control IE, etc, in addition to A-MAP IEs. So, again, this may further be an indication of a need for DL resources for DL control channels.

As an alternative method for resource allocation of the A-MAP IEs, the starting location L may be selectively defined to reduce the number of allocations that need to be specified in an assignment A-MAP IE. Additionally, selective sizes of resource allocations may be employed. Mechanisms may be used to identify the resource allocations in a given size of resource index field when the given resource index field cannot accommodate the allocations with all the possible combinations of locations and sizes.

With respect to selective locations, starting point gaps may be created for sets of allocation sizes. As a first example using a 96 LRU mapping, for allocation sizes 1-12 LRUs, the starting location L may be defined for every possible location. For allocation sizes 13-24 LRUs, the starting location L may be defined to start on odd numbered locations only. For allocation sizes 25-48 LRUs, L may be defined to start on every 4th odd numbered location (1, 5, 9, . . . ). For allocation sizes 49-88 LRUs, L may be defined to start on every 8th odd numbered location (1, 9, 17, . . . ). For allocation sizes 89-96 LRUs, L may be defined to start on every possible location.

As a second example, which is a variation of the above first example mapping, the gapped starting location L may defined as follows. For allocation sizes 1-12 LRUs, the starting location L may be defined for every possible location. For allocation sizes 13-24 LRUs, the starting location L may be defined to start at the locations at increments of 3 (i.e., from 1, 4, 7, . . . ). For allocation sizes 25-76 LRUs, L may be defined to start at the locations at increments of 4 (i.e., from 1, 5, 9, . . . ). For allocation sizes 77-96 LRUs, L may be defined to start at the one location for each of the allocation sizes; for a given size, the starting location may be chosen so that the allocation ends at the highest LRU index (i.e., 96). With this example variation, 2048 total allocations are possible, which may be signaled by an 11-bit RI field in the assignment IEs.

These defined mappings are provided as examples, and this embodiment should not be considered limited to these examples, as other similar variations may be used.

Using any of the above defined allocation sets having starting locations L with the “gapped allocations”, the larger size allocations may be mapped first, followed by mapping the smaller size allocations, which may start anywhere and to fill the gaps left by the large size allocations.

Table 2 shows valid allocations using selective locations for certain allocation sizes, in accordance with the above second example.

TABLE 2

| Assignable | | Num- |
|---|---|---|
| Resource | | ber of |
| Sizes | Contiguous LRUs Index | Indices |
| 1 | {1~1}, {2~2}, {3~3}, {4~4}, {5~5}, {6~6}, {7~7}, {8~8}, {9~9}, {10~10}, {11~11}, {12~12}, | 96 |
| | {13~13}, {14~14}, {15~15}, {16~16}, {17~17}, {18~18}, {19~19}, {20~20}, {21~21}, {22~22}, | |
| | {23~23}, {24~24}, {25~25}, {26~26}, {27~27}, {28~28}, {29~29}, {30~30}, {31~31}, {32~32}, | |
| | {33~33}, {34~34}, {35~35}, {36~36}, {37~37}, {38~38}, {39~39}, {40~40}, {41~41}, {42~42}, | |
| | {43~43}, {44~44}, {45~45}, {46~46}, {47~47}, {48~48}, {49~49}, {50~50}, {51~51}, {52~52}, | |
| | {53~53}, {54~54}, {55~55}, {56~56}, {57~57}, {58~58}, {59~59}, {60~60}, {61~61}, {62~62}, | |
| | {63~63}, {64~64}, {65~65}, {66~66}, {67~67}, {68~68}, {69~69}, {70~70}, {71~71}, {72~72}, | |
| | {73~73}, {74~74}, {75~75}, {76~76}, {77~77}, {78~78}, {79~79}, {80~80}, {81~81}, {82~82}, | |
| | {83~83}, {84~84}, {85~85}, {86~86}, {87~87}, {88~88}, {89~89}, {90~90}, {91~91}, {92~92}, | |
| | {93~93}, {94~94}, {95~95}, {96~96} | |
| 2 | {1~2}, {2~3}, {3~4}, {4~5}, {5~6}, {6~7}, {7~8}, {8~9}, {9~10}, {10~11}, {11~12}, {12~13}, | 95 |
| | {13~14}, {14~15}, {15~16}, {16~17}, {17~18}, {18~19}, {19~20}, {20~21}, {21~22}, {22~23}, | |
| | {23~24}, {24~25}, {25~26}, {26~27}, {27~28}, {28~29}, {29~30}, {30~31}, {31~32}, {32~33}, | |
| | {33~34}, {34~35}, {35~36}, {36~37}, {37~38}, {38~39}, {39~40}, {40~41}, {41~42}, {42~43}, | |
| | {43~44}, {44~45}, {45~46}, {46~47}, {47~48}, {48~49}, {49~50}, {50~51}, {51~52}, {52~53}, | |
| | {53~54}, {54~55}, {55~56}, {56~57}, {57~58}, {58~59}, {59~60}, {60~61}, {61~62}, {62~63}, | |
| | {63~64}, {64~65}, {65~66}, {66~67}, {67~68}, {68~69}, {69~70}, {70~71}, {71~72}, {72~73}, | |
| | {73~74}, {74~75}, {75~76}, {76~77}, {77~78}, {78~79}, {79~80}, {80~81}, {81~82}, {82~83}, | |
| | {83~84}, {84~85}, {85~86}, {86~87}, {87~88}, {88~89}, {89~90}, {90~91}, {91~92}, {92~93}, | |
| | {93~94}, {94~95}, {95~96} | |
| 3 | {1~3}, {2~4}, {3~5}, {4~6}, {5~7}, {6~8}, {7~9}, {8~10}, {9~11}, {10~12}, {11~13}, {12~14}, | 94 |
| | {13~15}, {14~16}, {15~17}, {16~18}, {17~19}, {18~20}, {19~21}, {20~22}, {21~23}, {22~14}, | |
| | {23~25}, {24~26}, {25~27}, {26~28}, {27~29}, {28~30}, {29~31}, {30~32}, {31~33}, {32~34}, | |
| | {33~35}, {34~36}, {35~37}, {36~38}, {37~39}, {38~40}, {39~41}, {40~42}, {41~43}, {42~44}, | |
| | {43~45}, {44~46}, {45~47}, {46~48}, {47~49}, {48~50}, {49~51}, {50~52}, {51~53}, {52~54}, | |
| | {53~55}, {54~56}, {55~57}, {56~58}, {57~59}, {58~60}, {59~61}, {60~62}, {61~63}, {62~64}, | |
| | {63~65}, {64~66}, {65~67}, {66~68}, {67~69}, {68~70}, {69~71}, {70~72}, {71~73}, {72~74}, | |
| | {73~75}, {74~76}, {75~77}, {76~78}, {77~79}, {78~80}, {79~81}, {80~82}, {81~83}, {82~84}, | |
| | {83~85}, {84~86}, {85~87}, {86~88}, {87~89}, {88~90}, {89~91}, {90~92}, {91~93}, {92~94}, | |
| | {93~95}, {94~96} | |
| 4 | {1~4}, {2~5}, {3~6}, {4~7}, {5~8}, {6~9}, {7~10}, {8~11}, {9~12}, {10~13}, {11~14}, {12~15}, | 93 |
| | {13~16}, {14~17}, {15~18}, {16~19}, {17~20}, {18~21}, {19~22}, {20~23}, {21~24}, {22~25}, | |
| | {23~26}, {24~27}, {25~28}, {26~29}, {27~30}, {28~31}, {29~32}, {30~33}, {31~34}, {32~35}, | |
| | {33~36}, {34~37}, {35~38}, {36~39}, {37~40}, {38~41}, {39~42}, {40~43}, {41~44}, {42~45}, | |
| | {43~46}, {44~47}, {45~48}, {46~49}, {47~50}, {48~51}, {49~52}, {50~53}, {51~54}, {52~55}, | |
| | {53~56}, {54~57}, {55~58}, {56~59}, {57~60}, {58~61}, {59~62}, {60~63}, {61~64}, {62~65}, | |
| | {63~66}, {64~67}, {65~68}, {66~69}, {67~70}, {68~71}, {69~72}, {70~73}, {71~74}, {72~75}, | |
| | {73~76}, {74~77}, {75~78}, {76~79}, {77~80}, {78~81}, {79~82}, {80~83}, {81~84}, {82~85}, | |
| | {83~86}, {84~87}, {85~88}, {86~89}, {87~90}, {88~91}, {89~92}, {90~93}, {91~94}, {92~95}, | |
| | {93~96} | |
| 5 | {1~5}, {2~6}, {3~7}, {4~8}, {5~9}, {6~10}, {7~11}, {8~12}, {9~13}, {10~14}, {11~15}, {12~16}, | 92 |
| | {13~17}, {14~18}, {15~19}, {16~20}, {17~21}, {18~22}, {19~23}, {20~24}, {21~25}, {22~26}, | |
| | {23~27}, {24~28}, {25~29}, {26~30}, {27~31}, {28~32}, {29~33}, {30~34}, {31~35}, {32~36}, | |
| | {33~37}, {34~38}, {35~39}, {36~40}, {37~41}, {38~42}, {39~43}, {40~44}, {41~45}, {42~46}, | |
| | {43~47}, {44~48}, {45~49}, {46~50}, {47~51}, {48~52}, {49~53}, {50~54}, {51~55}, {52~56}, | |
| | {53~57}, {54~58}, {55~59}, {56~60}, {57~61}, {58~62}, {59~63}, {60~64}, {61~65}, {62~66}, | |
| | {63~67}, {64~68}, {65~69}, {66~70}, {67~71}, {68~72}, {69~73}, {70~74}, {71~75}, {72~76}, | |
| | {73~77}, {74~78}, {75~79}, {76~80}, {77~81}, {78~82}, {79~83}, {80~84}, {81~85}, {82~86}, | |
| | {83~87}, {84~88}, {85~89}, {86~90}, {87~91}, {88~92}, {89~93}, {90~94}, {91~95}, {92~96} | |
| 6 | {1~6}, {2~7}, {3~8}, {4~9}, {5~10}, {6~11}, {7~12}, {8~13}, {9~14}, {10~15}, {11~16}, | 91 |
| | {12~17}, {13~18}, {14~19}, {15~20}, {16~21}, {17~22}, {18~23}, {19~24}, {20~25}, {21~26}, | |
| | {22~27}, {23~28}, {24~29}, {25~30}, {26~31}, {27~32}, {28~33}, {29~34}, {30~35}, {31~36}, | |
| | {32~37}, {33~38}, {34~39}, {35~40}, {36~41}, {37~42}, {38~43}, {39~44}, {40~45}, {41~46}, | |
| | {42~47}, {43~48}, {44~49}, {45~50}, {46~51}, {47~52}, {48~53}, {49~54}, {50~55}, {51~56}, | |
| | {52~57}, {53~58}, {54~59}, {55~60}, {56~61}, {57~62}, {58~63}, {59~64}, {60~65}, {61~66}, | |
| | {62~67}, {63~68}, {64~69}, {65~70}, {66~71}, {67~72}, {68~73}, {69~74}, {70~75}, {71~76}, | |
| | {72~77}, {73~78}, {74~79}, {75~80}, {76~81}, {77~82}, {78~83}, {79~84}, {80~85}, {81~86}, | |
| | {82~87}, {83~88}, {84~89}, {85~90}, {86~91}, {87~92}, {88~93}, {89~94}, {90~95}, {91~96} | |
| 7 | {1~7}, {2~8}, {3~9}, {4~10}, {5~11}, {6~12}, {7~13}, {8~14}, {9~15}, {10~16}, {11~17}, | 90 |
| | {12~18}, {13~19}, {14~20}, {15~21}, {16~22}, {17~23}, {18~24}, {19~25}, {20~26}, {21~27}, | |
| | {22~28}, {23~29}, {24~30}, {25~31}, {26~32}, {27~33}, {28~34}, {29~35}, {30~36}, {31~37}, | |
| | {32~38}, {33~39}, {34~40}, {35~41}, {36~42}, {37~43}, {38~44}, {39~45}, {40~46}, {41~47}, | |
| | {42~48}, {43~49}, {44~50}, {45~51}, {46~52}, {47~53}, {48~54}, {49~55}, {50~56}, {51~57}, | |
| | {52~58}, {53~59}, {54~60}, {55~61}, {56~62}, {57~63}, {58~64}, {59~65}, {60~66}, {61~67}, | |
| | {62~68}, {63~69}, {64~70}, {65~71}, {66~72}, {67~73}, {68~74}, {69~75}, {70~76}, {71~77}, | |
| | {72~78}, {73~79}, {74~80}, {75~81}, {76~82}, {77~83}, {78~84}, {79~85}, {80~86}, {81~87}, | |
| | {82~88}, {83~89}, {84~90}, {85~91}, {86~92}, {87~93}, {88~94}, {89~95}, {90~96} | |
| 8 | {1~8}, {2~9}, {3~10}, {4~11}, {5~12}, {6~13}, {7~14}, {8~15}, {9~16}, {10~17}, {11~18}, | 89 |
| | {12~19}, {13~20}, {14~21}, {15~22}, {16~23}, {17~24}, {18~25}, {19~26}, {20~27}, {21~28}, | |
| | {22~29}, {23~30}, {24~31}, {25~32}, {26~33}, {27~34}, {28~35}, {29~36}, {30~37}, {31~38}, | |
| | {32~39}, {33~40}, {34~41}, {35~42}, {36~43}, {37~44}, {38~45}, {39~46}, {40~47}, {41~48}, | |
| | {42~49}, {43~50}, {44~51}, {45~52}, {46~53}, {47~54}, {48~55}, {49~56}, {50~57}, {51~58}, | |
| | {52~59}, {53~60}, {54~61}, {55~62}, {56~63}, {57~64}, {58~65}, {59~66}, {60~67}, {61~68}, | |
| | {62~69}, {63~70}, {64~71}, {65~72}, {66~73}, {67~74}, {68~75}, {69~76}, {70~77}, {71~78}, | |
| | {72~79}, {73~80}, {74~81}, {75~82}, {76~83}, {77~84}, {78~85}, {79~86}, {80~87}, {81~88}, | |
| | {82~89}, {83~90}, {84~91}, {85~92}, {86~93}, {87~94}, {88~95}, {89~96} | |
| 9 | {1~9}, {2~10}, {3~11}, {4~12}, {5~13}, {6~14}, {7~15}, {8~16}, {9~17}, {10~18}, {11~19}, | 88 |
| | {12~20}, {13~21}, {14~22}, {15~23}, {16~24}, {17~25}, {18~26}, {19~27}, {20~28}, {21~29}, | |
| | {22~30}, {23~31}, {24~32}, {25~33}, {26~34}, {27~35}, {28~36}, {29~37}, {30~38}, {31~39}, | |
| | {32~40}, {33~41}, {34~42}, {35~43}, {36~44}, {37~45}, {38~46}, {39~47}, {40~48}, {41~49}, | |
| | {42~50}, {43~51}, {44~52}, {45~53}, {46~54}, {47~55}, {48~56}, {49~57}, {50~58}, {51~59}, | |
| | {52~60}, {53~61}, {54~62}, {55~63}, {56~64}, {57~65}, {58~66}, {59~67}, {60~68}, {61~69}, | |
| | {62~70}, {63~71}, {64~72}, {65~73}, {66~74}, {67~75}, {68~76}, {69~77}, {70~78}, {71~79}, | |
| | {72~80}, {73~81}, {74~82}, {75~83}, {76~84}, {77~85}, {78~86}, {79~87}, {80~88}, {81~89}, | |
| | {82~90}, {83~91}, {84~92}, {85~93}, {86~94}, {87~95}, {88~96} | |
| 10 | {1~10}, {2~11}, {3~12}, {4~13}, {5~14}, {6~15}, {7~16}, {8~17}, {9~18}, {10~19}, {11~20}, | 87 |
| | {12~21}, {13~22}, {14~23}, {15~24}, {16~25}, {17~26}, {18~27}, {19~28}, {20~29}, {21~30}, | |
| | {22~31}, {23~32}, {24~33}, {25~34}, {26~35}, {27~36}, {28~37}, {29~38}, {30~39}, {31~40}, | |
| | {32~41}, {33~42}, {34~43}, {35~44}, {36~45}, {37~46}, {38~47}, {39~48}, {40~49}, {41~50}, | |
| | {42~51}, {43~52}, {44~53}, {45~54}, {46~55}, {47~56}, {48~57}, {49~58}, {50~59}, {51~60}, | |
| | {52~61}, {53~62}, {54~63}, {55~64}, {56~65}, {57~66}, {58~67}, {59~68}, {60~69}, {61~70}, | |
| | {62~71}, {63~72}, {64~73}, {65~74}, {66~75}, {67~76}, {68~77}, {69~78}, {70~79}, {71~80}, | |
| | {72~81}, {73~82}, {74~83}, {75~84}, {76~85}, {77~86}, {78~87}, {79~88}, {80~89}, {81~90}, | |
| | {82~91}, {83~92}, {84~93}, {85~94}, {86~95}, {87~96} | |
| 11 | {1~11}, {2~12}, {3~13}, {4~14}, {5~15}, {6~16}, {7~17}, {8~18}, {9~19}, {10~20}, {11~21}, | 86 |
| | {12~22}, {13~23}, {14~24}, {15~25}, {16~26}, {17~27}, {18~28}, {19~29}, {20~30}, {21~31}, | |
| | {22~32}, {23~33}, {24~34}, {25~35}, {26~36}, {27~37}, {28~38}, {29~39}, {30~40}, {31~41}, | |
| | {32~42}, {33~43}, {34~44}, {35~45}, {36~46}, {37~47}, {38~48}, {39~49}, {40~50}, {41~51}, | |
| | {42~52}, {43~53}, {44~54}, {45~55}, {46~56}, {47~57}, {48~58}, {49~59}, {50~60}, {51~61}, | |
| | {52~62}, {53~63}, {54~64}, {55~65}, {56~66}, {57~67}, {58~68}, {59~69}, {60~70}, {61~71}, | |
| | {62~72}, {63~73}, {64~74}, {65~75}, {66~76}, {67~77}, {68~78}, {69~79}, {70~80}, {71~81}, | |
| | {72~82}, {73~83}, {74~84}, {75~85}, {76~86}, {77~87}, {78~88}, {79~89}, {80~90}, {81~91}, | |
| | {82~92}, {83~93}, {84~94}, {85~95}, {86~96} | |
| 12 | {1~12}, {2~13}, {3~14}, {4~15}, {5~16}, {6~17}, {7~18}, {8~19}, {9~20}, {10~21}, {11~22}, | 85 |
| | {12~23}, {13~24}, {14~25}, {15~26}, {16~27}, {17~28}, {18~29}, {19~30}, {20~31}, {21~32}, | |
| | {22~33}, {23~34}, {24~35}, {25~36}, {26~37}, {27~38}, {28~39}, {29~40}, {30~41}, {31~42}, | |
| | {32~43}, {33~44}, {34~45}, {35~46}, {36~47}, {37~48}, {38~49}, {39~50}, {40~51}, {41~52}, | |
| | {42~53}, {43~54}, {44~55}, {45~56}, {46~57}, {47~58}, {48~59}, {49~60}, {50~61}, {51~62}, | |
| | {52~63}, {53~64}, {54~65}, {55~66}, {56~67}, {57~68}, {58~69}, {59~70}, {60~71}, {61~72}, | |
| | {62~73}, {63~74}, {64~75}, {65~76}, {66~77}, {67~78}, {68~79}, {69~80}, {70~81}, {71~82}, | |
| | {72~83}, {73~84}, {74~85}, {75~86}, {76~87}, {77~88}, {78~89}, {79~90}, {80~91}, {81~92}, | |
| | {82~93}, {83~94}, {84~95}, {85~96} | |
| 13 | {1~13}, {4~16}, {7~19}, {10~22}, {13~25}, {16~28}, {19~31}, {22~34}, {25~37}, {28~40}, | 28 |
| | {31~43}, {34~46}, {37~49}, {40~52}, {43~55}, {46~58}, {49~61}, {52~64}, {55~67}, {58~70}, | |
| | {61~73}, {64~76}, {67~79}, {70~82}, {73~85}, {76~88}, {79~91}, {82~94} | |
| 14 | {1~14}, {4~17}, {7~20}, {10~23}, {13~26}, {16~29}, {19~32}, {22~35}, {25~38}, {28~41}, | 28 |
| | {31~44}, {34~47}, {37~50}, {40~53}, {43~56}, {46~59}, {49~62}, {52~65}, {55~68}, {58~71}, | |
| | {61~74}, {64~77}, {67~80}, {70~83}, {73~86}, {76~89}, {79~92}, {82~95} | |
| 15 | {1~15}, {4~18}, {7~21}, {10~24}, {13~27}, {16~30}, {19~33}, {22~36}, {25~39}, {28~42}, | 28 |
| | {31~45}, {34~48}, {37~51}, {40~54}, {43~57}, {46~60}, {49~63}, {52~66}, {55~69}, {58~72}, | |
| | {61~75}, {64~78}, {67~81}, {70~84}, {73~87}, {76~90}, {79~93}, {82~96} | |
| 16 | {1~16}, {4~19}, {7~22}, {10~25}, {13~28}, {16~31}, {19~34}, {22~37}, {25~40}, {28~43}, | 27 |
| | {31~46}, {34~49}, {37~52}, {40~55}, {43~58}, {46~61}, {49~64}, {52~67}, {55~70}, {58~73}, | |
| | {61~76}, {64~79}, {67~82}, {70~85}, {73~88}, {76~91}, {79~94} | |
| 17 | {1~17}, {4~20}, {7~23}, {10~26}, {13~29}, {16~32}, {19~35}, {22~38}, {25~41}, {28~44}, | 27 |
| | {31~47}, {34~50}, {37~53}, {40~56}, {43~59}, {46~62}, {49~65}, {52~68}, {55~71}, {58~74}, | |
| | {61~77}, {64~80}, {67~83}, {70~86}, {73~89}, {76~92}, {79~95} | |
| 18 | {1~18}, {4~21}, {7~24}, {10~27}, {13~30}, {16~33}, {19~36}, {22~39}, {25~42}, {28~45}, | 27 |
| | {31~48}, {34~51}, {37~54}, {40~57}, {43~60}, {46~63}, {49~66}, {52~69}, {55~72}, {58~75}, | |
| | {61~78}, {64~81}, {67~84}, {70~87}, {73~90}, {76~93}, {79~96} | |
| 19 | {1~19}, {4~22}, {7~25}, {10~28}, {13~31}, {16~34}, {19~37}, {22~40}, {25~43}, {28~46}, | 26 |
| | {31~49}, {34~52}, {37~55}, {40~58}, {43~61}, {46~64}, {49~67}, {52~70}, {55~73}, {58~76}, | |
| | {61~79}, {64~82}, {67~85}, {70~88}, {73~91}, {76~94} | |
| 20 | {1~20}, {4~23}, {7~26}, {10~29}, {13~32}, {16~35}, {19~38}, {22~41}, {25~44}, {28~47}, | 26 |
| | {31~50}, {34~53}, {37~56}, {40~59}, {43~62}, {46~65}, {49~68}, {52~71}, {55~74}, {58~77}, | |
| | {61~80}, {64~83}, {67~86}, {70~89}, {73~92}, {76~95} | |
| 21 | {1~21}, {4~24}, {7~27}, {10~30}, {13~33}, {16~36}, {19~39}, {22~42}, {25~45}, {28~48}, | 26 |
| | {31~51}, {34~54}, {37~57}, {40~60}, {43~63}, {46~66}, {49~69}, {52~72}, {55~75}, {58~78}, | |
| | {61~81}, {64~84}, {67~87}, {70~90}, {73~93}, {76~96} | |
| 22 | {1~22}, {4~25}, {7~28}, {10~31}, {13~34}, {16~37}, {19~40}, {22~43}, {25~46}, {28~49}, | 25 |
| | {31~52}, {34~55}, {37~58}, {40~61}, {43~64}, {46~67}, {49~70}, {52~73}, {55~76}, {58~79}, | |
| | {61~82}, {64~85}, {67~88}, {70~91}, {73~94} | |
| 23 | {1~23}, {4~26}, {7~29}, {10~32}, {13~35}, {16~38}, {19~41}, {22~44}, {25~47}, {28~50}, | 25 |
| | {31~53}, {34~56}, {37~59}, {40~62}, {43~65}, {46~68}, {49~71}, {52~74}, {55~77}, {58~80}, | |
| | {61~83}, {64~86}, {67~89}, {70~92}, {73~95} | |
| 24 | {1~24}, {4~27}, {7~30}, {10~33}, {13~36}, {16~39}, {19~42}, {22~45}, {25~48}, {28~51}, | 25 |
| | {31~54}, {34~57}, {37~60}, {40~63}, {43~66}, {46~69}, {49~72}, {52~75}, {55~78}, {58~81}, | |
| | {61~84}, {64~87}, {67~90}, {70~93}, {73~96} | |
| 25 | {1~25}, {5~29}, {9~33}, {13~37}, {17~41}, {21~45}, {25~49}, {29~53}, {33~57}, {37~61}, | 18 |
| | {41~65}, {45~69}, {49~73}, {53~77}, {57~81}, {61~85}, {65~89}, {69~93} | |
| 26 | {1~26}, {5~30}, {9~34}, {13~38}, {17~42}, {21~46}, {25~50}, {29~54}, {33~58}, {37~62}, | 18 |
| | {41~66}, {45~70}, {49~74}, {53~78}, {57~82}, {61~86}, {65~90}, {69~94} | |
| 27 | {1~27}, 15~311, 19~351, {13~39}, {17~43}, {21~47}, {25~51}, {29~55}, {33~59}, {37~63}, | 18 |
| | {41~67}, {45~71}, {49~75}, {53~79}, {57~83}, {61~87}, {65~91}, {69~95} | |
| 28 | {1~28}, {5~32}, {9~36}, {13~40}, {17~44}, {21~48}, {25~52}, {29~56}, {33~60}, {37~64}, | 18 |
| | {41~68}, {45~72}, {49~76}, {53~80}, {57~84}, {61~88}, {65~92}, {69~96} | |
| 29 | {1~29}, {5~33}, {9~37}, {13~41}, {17~45}, {21~49}, {25~53}, {29~57}, {33~61}, {37~65}, | 17 |
| | {41~69}, {45~73}, {49~77}, {53~81}, {57~85}, {61~89}, {65~93} | |
| 30 | {1~30}, {5~34}, {9~38}, {13~42}, {17~46}, {21~50}, {25~54}, {29~58}, {33~62}, {37~66}, | 17 |
| | {41~70}, {45~74}, {49~78}, {53~82}, {57~86}, {61~90}, {65~94} | |
| 31 | {1~31}, {5~35}, {9~39}, {13~43}, {17~47}, {21~51}, {25~55}, {29~59}, {33~63}, {37~67}, | 17 |
| | {41~71}, {45~75}, {49~79}, {53~83}, {57~87}, {61~91}, {65~95} | |
| 32 | {1~32}, {5~36}, {9~40}, {13~44}, {17~48}, {21~52}, {25~56}, {29~60}, {33~64}, {37~68}, | 17 |
| | {41~72}, {45~76}, {49~80}, {53~84}, {57~88}, {61~92}, {65~96} | |
| 33 | {1~33}, {5~37}, {9~41}, {13~45}, {17~49}, {21~53}, {25~57}, {29~61}, {33~65}, {37~69}, | 16 |
| | {41~73}, {45~77}, {49~81}, {53~85}, {57~89}, {61~93} | |
| 34 | {1~34}, {5~38}, {9~42}, {13~46}, {17~50}, {21~54}, {25~58}, {29~62}, {33~66}, {37~70}, | 16 |
| | {41~74}, {45~78}, {49~82}, {53~86}, {57~90}, {61~94} | |
| 35 | {1~35}, {5~39}, {9~43}, {13~47}, {17~51}, {21~55}, {25~59}, {29~63}, {33~67}, {37~71}, | 16 |
| | {41~75}, {45~79}, {49~83}, {53~87}, {57~91}, {61~95} | |
| 36 | {1~36}, {5~40}, {9~44}, {13~48}, {17~52}, {21~56}, {25~60}, {29~64}, {33~68}, {37~72}, | 16 |
| | {41~76}, {45~80}, {49~84}, {53~88}, {57~92}, {61~96} | |
| 37 | {1~37}, {5~41}, {9~45}, {13~49}, {17~53}, {21~57}, {25~61}, {29~65}, {33~69}, {37~73}, | 15 |
| | {41~77}, {45~81}, {49~85}, {53~89}, {57~93} | |
| 38 | {1~38}, {5~42}, {9~46}, {13~50}, {17~54}, {21~58}, {25~62}, {29~66}, {33~70}, {37~74}, | 15 |
| | {41~78}, {45~82}, {49~86}, {53~90}, {57~94} | |
| 39 | {1~39}, {5~43}, {9~47}, {13~51}, {17~55}, {21~59}, {25~63}, {29~67}, {33~71}, {37~75}, | 15 |
| | {41~79}, {45~83}, {49~87}, {53~91}, {57~95} | |
| 40 | {1~40}, {5~44}, {9~48}, {13~52}, {17~56}, {21~60}, {25~64}, {29~68}, {33~72}, {37~76}, | 15 |
| | {41~80}, {45~84}, {49~88}, {53~92}, {57~96} | |
| 41 | {1~41}, {5~45}, {9~49}, {13~53}, {17~57}, {21~61}, {25~65}, {29~69}, {33~73}, {37~77}, | 14 |
| | {41~81}, {45~85}, {49~89}, {53~93} | |
| 42 | {1~42}, {5~46}, {9~50}, {13~54}, {17~58}, {21~62}, {25~66}, {29~70}, {33~74}, {37~78}, | 14 |
| | {41~82}, {45~86}, {49~90}, {53~94} | |
| 43 | {1~43}, {5~47}, {9~51}, {13~55}, {17~59}, {21~63}, {25~67}, {29~71}, {33~75}, {37~79}, | 14 |
| | {41~83}, {45~87}, {49~91}, {53~95} | |
| 44 | {1~44}, {5~48}, {9~52}, {13~56}, {17~60}, {21~64}, {25~68}, {29~72}, {33~76}, {37~80}, | 14 |
| | {41~84}, {45~88}, {49~92}, {53~96} | |
| 45 | {1~45}, {5~49}, {9~53}, {13~57}, {17~61}, {21~65}, {25~69}, {29~73}, {33~77}, {37~81}, | 13 |
| | {41~85}, {45~89}, {49~93} | |
| 46 | {1~46}, {5~50}, {9~54}, {13~58}, {17~62}, {21~66}, {25~70}, {29~74}, {33~78}, {37~82}, | 13 |
| | {41~86}, {45~90}, {49~94} | |
| 47 | {1~47}, {5~51}, {9~55}, {13~59}, {17~63}, {21~67}, {25~71}, {29~75}, {33~79}, {37~83}, | 13 |
| | {41~87}, {45~91}, {49~95} | |
| 48 | {1~48}, {5~52}, {9~56}, {13~60}, {17~64}, {21~68}, {25~72}, {29~76}, {33~80}, {37~84}, | 13 |
| | {41~88}, {45~92}, {49~96} | |
| 49 | {1~49}, {5~53}, {9~57}, {13~61}, {17~65}, {21~69}, {25~73}, {29~77}, {33~81}, {37~85}, | 12 |
| | {41~89}, {45~93} | |
| 50 | {1~50}, {5~54}, {9~58}, {13~62}, {17~66}, {21~70}, {25~74}, {29~78}, {33~82}, {37~86}, | 12 |
| | {41~90}, {45~94} | |
| 51 | {1~51}, {5~55}, {9~59}, {13~63}, {17~67}, {21~71}, {25~75}, {29~79}, {33~83}, {37~87}, | 12 |
| | {41~91}, {45~95} | |
| 52 | {1~52}, {5~56}, {9~60}, {13~64}, {17~68}, {21~72}, {25~76}, {29~80}, {33~84}, {37~88}, | 12 |
| | {41~92}, {45~96} | |
| 53 | {1~53}, {5~57}, {9~61}, {13~65}, {17~69}, {21~73}, {25~77}, {29~81}, {33~85}, {37~89}, | 11 |
| | {41~93} | |
| 54 | {1~54}, {5~58}, {9~62}, {13~66}, {17~70}, {21~74}, {25~78}, {29~82}, {33~86}, {37~90}, | 11 |
| | {41~94} | |
| 55 | {1~55}, {5~59}, {9~63}, {13~67}, {17~71}, {21~75}, {25~79}, {29~83}, {33~87}, {37~91}, | 11 |
| | {41~95} | |
| 56 | {1~56}, {5~60}, {9~64}, {13~68}, {17~72}, {21~76}, {25~80}, {29~84}, {33~88}, {37~92}, | 11 |
| | {41~96} | |
| 57 | {1~57}, {5~61}, {9~65}, {13~69}, {17~73}, {21~77}, {25~81}, {29~85}, {33~89}, {37~93} | 10 |
| 58 | {1~58}, {5~62}, {9~66}, {13~70}, {17~74}, {21~78}, {25~82}, {29~86}, {33~90}, {37~94} | 10 |
| 59 | {1~59}, {5~63}, {9~67}, {13~71}, {17~75}, {21~79}, {25~83}, {29~87}, {33~91}, {37~95} | 10 |
| 60 | {1~60}, {5~64}, {9~68}, {13~72}, {17~76}, {21~80}, {25~84}, {29~88}, {33~92}, {37~96} | 10 |
| 61 | {1~61}, {5~65}, {9~69}, {13~73}, {17~77}, {21~81}, {25~85}, {29~89}, {33~93} | 9 |
| 62 | {1~62}, {5~66}, {9~70}, {13~74}, {17~78}, {21~82}, {25~86}, {29~90}, {33~94} | 9 |
| 63 | {1~63}, {5~67}, {9~71}, {13~75}, {17~79}, {21~83}, {25~87}, {29~91}, {33~95} | 9 |
| 64 | {1~64}, {5~68}, {9~72}, {13~76}, {17~80}, {21~84}, {25~88}, {29~92}, {33~96} | 9 |
| 65 | {1~65}, {5~69}, {9~73}, {13~77}, {17~81}, {21~85}, {25~89}, {29~93} | 8 |
| 66 | {1~66}, {5~70}, {9~74}, {13~78}, {17~82}, {21~86}, {25~90}, {29~94} | 8 |
| 67 | {1~67}, {5~71}, {9~75}, {13~79}, {17~83}, {21~87}, {25~91}, {29~95} | 8 |
| 68 | {1~68}, {5~72}, {9~76}, {13~80}, {17~84}, {21~88}, {25~92}, {29~96} | 8 |
| 69 | {1~69}, {5~73}, {9~77}, {13~81}, {17~85}, {21~89}, {25~93} | 7 |
| 70 | {1~70}, {5~74}, {9~78}, {13~82}, {17~86}, {21~90}, {25~94} | 7 |
| 71 | {1~71}, {5~75}, {9~79}, {13~83}, {17~87}, {21~91}, {25~95} | 7 |
| 72 | {1~72}, {5~76}, {9~80}, {13~84}, {17~88}, {21~92}, {25~96} | 7 |
| 73 | {1~73}, {5~77}, {9~81}, {13~85}, {17~89}, {21~93} | 6 |
| 74 | {1~74}, {5~78}, {9~82}, {13~86}, {17~90}, {21~94} | 6 |
| 75 | {1~75}, {5~79}, {9~83}, {13~87}, {17~91}, {21~95} | 6 |
| 76 | {1~76}, {5~80}, {9~84}, {13~88}, {17~92}, {21~96} | 6 |
| 77 | {20~96} | 1 |
| 78 | {19~96} | 1 |
| 79 | {18~96} | 1 |
| 80 | {17~96} | 1 |
| 81 | {16~96} | 1 |
| 82 | {15~96} | 1 |
| 83 | {14~96} | 1 |
| 84 | {13~96} | 1 |
| 85 | {12~96} | 1 |
| 86 | {11~96} | 1 |
| 87 | {10~96} | 1 |
| 88 | {9~96} | 1 |
| 89 | {8~96} | 1 |
| 90 | {7~96} | 1 |
| 91 | {6~96} | 1 |
| 92 | {5~96} | 1 |
| 93 | {4~96} | 1 |
| 94 | {3~96} | 1 |
| 95 | {2~96} | 1 |
| 96 | {1~96} | 1 |
| | | Total = |
| | | 2048 |

Based on the defined selective locations L for certain allocation sizes as shown in Table 1, an example 11-bit RI index assignment may be generated as shown in Table 3.

TABLE 3

| Index | Start | Length |
|---|---|---|
| 1 | 1 | 1 |
| 2 | 2 | 1 |
| 3 | 3 | 1 |
| 4 | 4 | 1 |
| 5 | 5 | 1 |
| 6 | 6 | 1 |
| 7 | 7 | 1 |
| 8 | 8 | 1 |
| 9 | 9 | 1 |
| 10 | 10 | 1 |
| 11 | 11 | 1 |
| 12 | 12 | 1 |
| 13 | 13 | 1 |
| 14 | 14 | 1 |
| 15 | 15 | 1 |
| 16 | 16 | 1 |
| 17 | 17 | 1 |
| 18 | 18 | 1 |
| 19 | 19 | 1 |
| 20 | 20 | 1 |
| 21 | 21 | 1 |
| 22 | 22 | 1 |
| 23 | 23 | 1 |
| 24 | 24 | 1 |
| 25 | 25 | 1 |
| 26 | 26 | 1 |
| 27 | 27 | 1 |
| 28 | 28 | 1 |
| 29 | 29 | 1 |
| 30 | 30 | 1 |
| 31 | 31 | 1 |
| 32 | 32 | 1 |
| 33 | 33 | 1 |
| 34 | 34 | 1 |
| 35 | 35 | 1 |
| 36 | 36 | 1 |
| 37 | 37 | 1 |
| 38 | 38 | 1 |
| 39 | 39 | 1 |
| 40 | 40 | 1 |
| 41 | 41 | 1 |
| 42 | 42 | 1 |
| 43 | 43 | 1 |
| 44 | 44 | 1 |
| 45 | 45 | 1 |
| 46 | 46 | 1 |
| 47 | 47 | 1 |
| 48 | 48 | 1 |
| 49 | 49 | 1 |
| 50 | 50 | 1 |
| 51 | 51 | 1 |
| 52 | 52 | 1 |
| 53 | 53 | 1 |
| 54 | 54 | 1 |
| 55 | 55 | 1 |
| 56 | 56 | 1 |
| 57 | 57 | 1 |
| 58 | 58 | 1 |
| 59 | 59 | 1 |
| 60 | 60 | 1 |
| 61 | 61 | 1 |
| 62 | 62 | 1 |
| 63 | 63 | 1 |
| 64 | 64 | 1 |
| 65 | 65 | 1 |
| 66 | 66 | 1 |
| 67 | 67 | 1 |
| 68 | 68 | 1 |
| 69 | 69 | 1 |
| 70 | 70 | 1 |
| 71 | 71 | 1 |
| 72 | 72 | 1 |
| 73 | 73 | 1 |
| 74 | 74 | 1 |
| 75 | 75 | 1 |
| 76 | 76 | 1 |
| 77 | 77 | 1 |
| 78 | 78 | 1 |
| 79 | 79 | 1 |
| 80 | 80 | 1 |
| 81 | 81 | 1 |
| 82 | 82 | 1 |
| 83 | 83 | 1 |
| 84 | 84 | 1 |
| 85 | 85 | 1 |
| 86 | 86 | 1 |
| 87 | 87 | 1 |
| 88 | 88 | 1 |
| 89 | 89 | 1 |
| 90 | 90 | 1 |
| 91 | 91 | 1 |
| 92 | 92 | 1 |
| 93 | 93 | 1 |
| 94 | 94 | 1 |
| 95 | 95 | 1 |
| 96 | 96 | 1 |
| 97 | 1 | 2 |
| 98 | 2 | 2 |
| 99 | 3 | 2 |
| 100 | 4 | 2 |
| 101 | 5 | 2 |
| 102 | 6 | 2 |
| 103 | 7 | 2 |
| 104 | 8 | 2 |
| 105 | 9 | 2 |
| 106 | 10 | 2 |
| 107 | 11 | 2 |
| 108 | 12 | 2 |
| 109 | 13 | 2 |
| 110 | 14 | 2 |
| 111 | 15 | 2 |
| 112 | 16 | 2 |
| 113 | 17 | 2 |
| 114 | 18 | 2 |
| 115 | 19 | 2 |
| 116 | 20 | 2 |
| 117 | 21 | 2 |
| 118 | 22 | 2 |
| 119 | 23 | 2 |
| 120 | 24 | 2 |
| 121 | 25 | 2 |
| 122 | 26 | 2 |
| 123 | 27 | 2 |
| 124 | 28 | 2 |
| 125 | 29 | 2 |
| 126 | 30 | 2 |
| 127 | 31 | 2 |
| 128 | 32 | 2 |
| 129 | 33 | 2 |
| 130 | 34 | 2 |
| 131 | 35 | 2 |
| 132 | 36 | 2 |
| 133 | 37 | 2 |
| 134 | 38 | 2 |
| 135 | 39 | 2 |
| 136 | 40 | 2 |
| 137 | 41 | 2 |
| 138 | 42 | 2 |
| 139 | 43 | 2 |
| 140 | 44 | 2 |
| 141 | 45 | 2 |
| 142 | 46 | 2 |
| 143 | 47 | 2 |
| 144 | 48 | 2 |
| 145 | 49 | 2 |
| 146 | 50 | 2 |
| 147 | 51 | 2 |
| 148 | 52 | 2 |
| 149 | 53 | 2 |
| 150 | 54 | 2 |
| 151 | 55 | 2 |
| 152 | 56 | 2 |
| 153 | 57 | 2 |
| 154 | 58 | 2 |
| 155 | 59 | 2 |
| 156 | 60 | 2 |
| 157 | 61 | 2 |
| 158 | 62 | 2 |
| 159 | 63 | 2 |
| 160 | 64 | 2 |
| 161 | 65 | 2 |
| 162 | 66 | 2 |
| 163 | 67 | 2 |
| 164 | 68 | 2 |
| 165 | 69 | 2 |
| 166 | 70 | 2 |
| 167 | 71 | 2 |
| 168 | 72 | 2 |
| 169 | 73 | 2 |
| 170 | 74 | 2 |
| 171 | 75 | 2 |
| 172 | 76 | 2 |
| 173 | 77 | 2 |
| 174 | 78 | 2 |
| 175 | 79 | 2 |
| 176 | 80 | 2 |
| 177 | 81 | 2 |
| 178 | 82 | 2 |
| 179 | 83 | 2 |
| 180 | 84 | 2 |
| 181 | 85 | 2 |
| 182 | 86 | 2 |
| 183 | 87 | 2 |
| 184 | 88 | 2 |
| 185 | 89 | 2 |
| 186 | 90 | 2 |
| 187 | 91 | 2 |
| 188 | 92 | 2 |
| 189 | 93 | 2 |
| 190 | 94 | 2 |
| 191 | 95 | 2 |
| 192 | 1 | 3 |
| 193 | 2 | 3 |
| 194 | 3 | 3 |
| 195 | 4 | 3 |
| 196 | 5 | 3 |
| 197 | 6 | 3 |
| 198 | 7 | 3 |
| 199 | 8 | 3 |
| 200 | 9 | 3 |
| 201 | 10 | 3 |
| 202 | 11 | 3 |
| 203 | 12 | 3 |
| 204 | 13 | 3 |
| 205 | 14 | 3 |
| 206 | 15 | 3 |
| 207 | 16 | 3 |
| 208 | 17 | 3 |
| 209 | 18 | 3 |
| 210 | 19 | 3 |
| 211 | 20 | 3 |
| 212 | 21 | 3 |
| 213 | 22 | 3 |
| 214 | 23 | 3 |
| 215 | 24 | 3 |
| 216 | 25 | 3 |
| 217 | 26 | 3 |
| 218 | 27 | 3 |
| 219 | 28 | 3 |
| 220 | 29 | 3 |
| 221 | 30 | 3 |
| 222 | 31 | 3 |
| 223 | 32 | 3 |
| 224 | 33 | 3 |
| 225 | 34 | 3 |
| 226 | 35 | 3 |
| 227 | 36 | 3 |
| 228 | 37 | 3 |
| 229 | 38 | 3 |
| 230 | 39 | 3 |
| 231 | 40 | 3 |
| 232 | 41 | 3 |
| 233 | 42 | 3 |
| 234 | 43 | 3 |
| 235 | 44 | 3 |
| 236 | 45 | 3 |
| 237 | 46 | 3 |
| 238 | 47 | 3 |
| 239 | 48 | 3 |
| 240 | 49 | 3 |
| 241 | 50 | 3 |
| 242 | 51 | 3 |
| 243 | 52 | 3 |
| 244 | 53 | 3 |
| 245 | 54 | 3 |
| 246 | 55 | 3 |
| 247 | 56 | 3 |
| 248 | 57 | 3 |
| 249 | 58 | 3 |
| 250 | 59 | 3 |
| 251 | 60 | 3 |
| 252 | 61 | 3 |
| 253 | 62 | 3 |
| 254 | 63 | 3 |
| 255 | 64 | 3 |
| 256 | 65 | 3 |
| 257 | 66 | 3 |
| 258 | 67 | 3 |
| 259 | 68 | 3 |
| 260 | 69 | 3 |
| 261 | 70 | 3 |
| 262 | 71 | 3 |
| 263 | 72 | 3 |
| 264 | 73 | 3 |
| 265 | 74 | 3 |
| 266 | 75 | 3 |
| 267 | 76 | 3 |
| 268 | 77 | 3 |
| 269 | 78 | 3 |
| 270 | 79 | 3 |
| 271 | 80 | 3 |
| 272 | 81 | 3 |
| 273 | 82 | 3 |
| 274 | 83 | 3 |
| 275 | 84 | 3 |
| 276 | 85 | 3 |
| 277 | 86 | 3 |
| 278 | 87 | 3 |
| 279 | 88 | 3 |
| 280 | 89 | 3 |
| 281 | 90 | 3 |
| 282 | 91 | 3 |
| 283 | 92 | 3 |
| 284 | 93 | 3 |
| 285 | 94 | 3 |
| 286 | 1 | 4 |
| 287 | 2 | 4 |
| 288 | 3 | 4 |
| 289 | 4 | 4 |
| 290 | 5 | 4 |
| 291 | 6 | 4 |
| 292 | 7 | 4 |
| 293 | 8 | 4 |
| 294 | 9 | 4 |
| 295 | 10 | 4 |
| 296 | 11 | 4 |
| 297 | 12 | 4 |
| 298 | 13 | 4 |
| 299 | 14 | 4 |
| 300 | 15 | 4 |
| 301 | 16 | 4 |
| 302 | 17 | 4 |
| 303 | 18 | 4 |
| 304 | 19 | 4 |
| 305 | 20 | 4 |
| 306 | 21 | 4 |
| 307 | 22 | 4 |
| 308 | 23 | 4 |
| 309 | 24 | 4 |
| 310 | 25 | 4 |
| 311 | 26 | 4 |
| 312 | 27 | 4 |
| 313 | 28 | 4 |
| 314 | 29 | 4 |
| 315 | 30 | 4 |
| 316 | 31 | 4 |
| 317 | 32 | 4 |
| 318 | 33 | 4 |
| 319 | 34 | 4 |
| 320 | 35 | 4 |
| 321 | 36 | 4 |
| 322 | 37 | 4 |
| 323 | 38 | 4 |
| 324 | 39 | 4 |
| 325 | 40 | 4 |
| 326 | 41 | 4 |
| 327 | 42 | 4 |
| 328 | 43 | 4 |
| 329 | 44 | 4 |
| 330 | 45 | 4 |
| 331 | 46 | 4 |
| 332 | 47 | 4 |
| 333 | 48 | 4 |
| 334 | 49 | 4 |
| 335 | 50 | 4 |
| 336 | 51 | 4 |
| 337 | 52 | 4 |
| 338 | 53 | 4 |
| 339 | 54 | 4 |
| 340 | 55 | 4 |
| 341 | 56 | 4 |
| 342 | 57 | 4 |
| 343 | 58 | 4 |
| 344 | 59 | 4 |
| 345 | 60 | 4 |
| 346 | 61 | 4 |
| 347 | 62 | 4 |
| 348 | 63 | 4 |
| 349 | 64 | 4 |
| 350 | 65 | 4 |
| 351 | 66 | 4 |
| 352 | 67 | 4 |
| 353 | 68 | 4 |
| 354 | 69 | 4 |
| 355 | 70 | 4 |
| 356 | 71 | 4 |
| 357 | 72 | 4 |
| 358 | 73 | 4 |
| 359 | 74 | 4 |
| 360 | 75 | 4 |
| 361 | 76 | 4 |
| 362 | 77 | 4 |
| 363 | 78 | 4 |
| 364 | 79 | 4 |
| 365 | 80 | 4 |
| 366 | 81 | 4 |
| 367 | 82 | 4 |
| 368 | 83 | 4 |
| 369 | 84 | 4 |
| 370 | 85 | 4 |
| 371 | 86 | 4 |
| 372 | 87 | 4 |
| 373 | 88 | 4 |
| 374 | 89 | 4 |
| 375 | 90 | 4 |
| 376 | 91 | 4 |
| 377 | 92 | 4 |
| 378 | 93 | 4 |
| 379 | 1 | 5 |
| 380 | 2 | 5 |
| 381 | 3 | 5 |
| 382 | 4 | 5 |
| 383 | 5 | 5 |
| 384 | 6 | 5 |
| 385 | 7 | 5 |
| 386 | 8 | 5 |
| 387 | 9 | 5 |
| 388 | 10 | 5 |
| 389 | 11 | 5 |
| 390 | 12 | 5 |
| 391 | 13 | 5 |
| 392 | 14 | 5 |
| 393 | 15 | 5 |
| 394 | 16 | 5 |
| 395 | 17 | 5 |
| 396 | 18 | 5 |
| 397 | 19 | 5 |
| 398 | 20 | 5 |
| 399 | 21 | 5 |
| 400 | 22 | 5 |
| 401 | 23 | 5 |
| 402 | 24 | 5 |
| 403 | 25 | 5 |
| 404 | 26 | 5 |
| 405 | 27 | 5 |
| 406 | 28 | 5 |
| 407 | 29 | 5 |
| 408 | 30 | 5 |
| 409 | 31 | 5 |
| 410 | 32 | 5 |
| 411 | 33 | 5 |
| 412 | 34 | 5 |
| 413 | 35 | 5 |
| 414 | 36 | 5 |
| 415 | 37 | 5 |
| 416 | 38 | 5 |
| 417 | 39 | 5 |
| 418 | 40 | 5 |
| 419 | 41 | 5 |
| 420 | 42 | 5 |
| 421 | 43 | 5 |
| 422 | 44 | 5 |
| 423 | 45 | 5 |
| 424 | 46 | 5 |
| 425 | 47 | 5 |
| 426 | 48 | 5 |
| 427 | 49 | 5 |
| 428 | 50 | 5 |
| 429 | 51 | 5 |
| 430 | 52 | 5 |
| 431 | 53 | 5 |
| 432 | 54 | 5 |
| 433 | 55 | 5 |
| 434 | 56 | 5 |
| 435 | 57 | 5 |
| 436 | 58 | 5 |
| 437 | 59 | 5 |
| 438 | 60 | 5 |
| 439 | 61 | 5 |
| 440 | 62 | 5 |
| 441 | 63 | 5 |
| 442 | 64 | 5 |
| 443 | 65 | 5 |
| 444 | 66 | 5 |
| 445 | 67 | 5 |
| 446 | 68 | 5 |
| 447 | 69 | 5 |
| 448 | 70 | 5 |
| 449 | 71 | 5 |
| 450 | 72 | 5 |
| 451 | 73 | 5 |
| 452 | 74 | 5 |
| 453 | 75 | 5 |
| 454 | 76 | 5 |
| 455 | 77 | 5 |
| 456 | 78 | 5 |
| 457 | 79 | 5 |
| 458 | 80 | 5 |
| 459 | 81 | 5 |
| 460 | 82 | 5 |
| 461 | 83 | 5 |
| 462 | 84 | 5 |
| 463 | 85 | 5 |
| 464 | 86 | 5 |
| 465 | 87 | 5 |
| 466 | 88 | 5 |
| 467 | 89 | 5 |
| 468 | 90 | 5 |
| 469 | 91 | 5 |
| 470 | 92 | 5 |
| 471 | 1 | 6 |
| 472 | 2 | 6 |
| 473 | 3 | 6 |
| 474 | 4 | 6 |
| 475 | 5 | 6 |
| 476 | 6 | 6 |
| 477 | 7 | 6 |
| 478 | 8 | 6 |
| 479 | 9 | 6 |
| 480 | 10 | 6 |
| 481 | 11 | 6 |
| 482 | 12 | 6 |
| 483 | 13 | 6 |
| 484 | 14 | 6 |
| 485 | 15 | 6 |
| 486 | 16 | 6 |
| 487 | 17 | 6 |
| 488 | 18 | 6 |
| 489 | 19 | 6 |
| 490 | 20 | 6 |
| 491 | 21 | 6 |
| 492 | 22 | 6 |
| 493 | 23 | 6 |
| 494 | 24 | 6 |
| 495 | 25 | 6 |
| 496 | 26 | 6 |
| 497 | 27 | 6 |
| 498 | 28 | 6 |
| 499 | 29 | 6 |
| 500 | 30 | 6 |
| 501 | 31 | 6 |
| 502 | 32 | 6 |
| 503 | 33 | 6 |
| 504 | 34 | 6 |
| 505 | 35 | 6 |
| 506 | 36 | 6 |
| 507 | 37 | 6 |
| 508 | 38 | 6 |
| 509 | 39 | 6 |
| 510 | 40 | 6 |
| 511 | 41 | 6 |
| 512 | 42 | 6 |
| 513 | 43 | 6 |
| 514 | 44 | 6 |
| 515 | 45 | 6 |
| 516 | 46 | 6 |
| 517 | 47 | 6 |
| 518 | 48 | 6 |
| 519 | 49 | 6 |
| 520 | 50 | 6 |
| 521 | 51 | 6 |
| 522 | 52 | 6 |
| 523 | 53 | 6 |
| 524 | 54 | 6 |
| 525 | 55 | 6 |
| 526 | 56 | 6 |
| 527 | 57 | 6 |
| 528 | 58 | 6 |
| 529 | 59 | 6 |
| 530 | 60 | 6 |
| 531 | 61 | 6 |
| 532 | 62 | 6 |
| 533 | 63 | 6 |
| 534 | 64 | 6 |
| 535 | 65 | 6 |
| 536 | 66 | 6 |
| 537 | 67 | 6 |
| 538 | 68 | 6 |
| 539 | 69 | 6 |
| 540 | 70 | 6 |
| 541 | 71 | 6 |
| 542 | 72 | 6 |
| 543 | 73 | 6 |
| 544 | 74 | 6 |
| 545 | 75 | 6 |
| 546 | 76 | 6 |
| 547 | 77 | 6 |
| 548 | 78 | 6 |
| 549 | 79 | 6 |
| 550 | 80 | 6 |
| 551 | 81 | 6 |
| 552 | 82 | 6 |
| 553 | 83 | 6 |
| 554 | 84 | 6 |
| 555 | 85 | 6 |
| 556 | 86 | 6 |
| 557 | 87 | 6 |
| 558 | 88 | 6 |
| 559 | 89 | 6 |
| 560 | 90 | 6 |
| 561 | 91 | 6 |
| 562 | 1 | 7 |
| 563 | 2 | 7 |
| 564 | 3 | 7 |
| 565 | 4 | 7 |
| 566 | 5 | 7 |
| 567 | 6 | 7 |
| 568 | 7 | 7 |
| 569 | 8 | 7 |
| 570 | 9 | 7 |
| 571 | 10 | 7 |
| 572 | 11 | 7 |
| 573 | 12 | 7 |
| 574 | 13 | 7 |
| 575 | 14 | 7 |
| 576 | 15 | 7 |
| 577 | 16 | 7 |
| 578 | 17 | 7 |
| 579 | 18 | 7 |
| 580 | 19 | 7 |
| 581 | 20 | 7 |
| 582 | 21 | 7 |
| 583 | 22 | 7 |
| 584 | 23 | 7 |
| 585 | 24 | 7 |
| 586 | 25 | 7 |
| 587 | 26 | 7 |
| 588 | 27 | 7 |
| 589 | 28 | 7 |
| 590 | 29 | 7 |
| 591 | 30 | 7 |
| 592 | 31 | 7 |
| 593 | 32 | 7 |
| 594 | 33 | 7 |
| 595 | 34 | 7 |
| 596 | 35 | 7 |
| 597 | 36 | 7 |
| 598 | 37 | 7 |
| 599 | 38 | 7 |
| 600 | 39 | 7 |
| 601 | 40 | 7 |
| 602 | 41 | 7 |
| 603 | 42 | 7 |
| 604 | 43 | 7 |
| 605 | 44 | 7 |
| 606 | 45 | 7 |
| 607 | 46 | 7 |
| 608 | 47 | 7 |
| 609 | 48 | 7 |
| 610 | 49 | 7 |
| 611 | 50 | 7 |
| 612 | 51 | 7 |
| 613 | 52 | 7 |
| 614 | 53 | 7 |
| 615 | 54 | 7 |
| 616 | 55 | 7 |
| 617 | 56 | 7 |
| 618 | 57 | 7 |
| 619 | 58 | 7 |
| 620 | 59 | 7 |
| 621 | 60 | 7 |
| 622 | 61 | 7 |
| 623 | 62 | 7 |
| 624 | 63 | 7 |
| 625 | 64 | 7 |
| 626 | 65 | 7 |
| 627 | 66 | 7 |
| 628 | 67 | 7 |
| 629 | 68 | 7 |
| 630 | 69 | 7 |
| 631 | 70 | 7 |
| 632 | 71 | 7 |
| 633 | 72 | 7 |
| 634 | 73 | 7 |
| 635 | 74 | 7 |
| 636 | 75 | 7 |
| 637 | 76 | 7 |
| 638 | 77 | 7 |
| 639 | 78 | 7 |
| 640 | 79 | 7 |
| 641 | 80 | 7 |
| 642 | 81 | 7 |
| 643 | 82 | 7 |
| 644 | 83 | 7 |
| 645 | 84 | 7 |
| 646 | 85 | 7 |
| 647 | 86 | 7 |
| 648 | 87 | 7 |
| 649 | 88 | 7 |
| 650 | 89 | 7 |
| 651 | 90 | 7 |
| 652 | 1 | 8 |
| 653 | 2 | 8 |
| 654 | 3 | 8 |
| 655 | 4 | 8 |
| 656 | 5 | 8 |
| 657 | 6 | 8 |
| 658 | 7 | 8 |
| 659 | 8 | 8 |
| 660 | 9 | 8 |
| 661 | 10 | 8 |
| 662 | 11 | 8 |
| 663 | 12 | 8 |
| 664 | 13 | 8 |
| 665 | 14 | 8 |
| 666 | 15 | 8 |
| 667 | 16 | 8 |
| 668 | 17 | 8 |
| 669 | 18 | 8 |
| 670 | 19 | 8 |
| 671 | 20 | 8 |
| 672 | 21 | 8 |
| 673 | 22 | 8 |
| 674 | 23 | 8 |
| 675 | 24 | 8 |
| 676 | 25 | 8 |
| 677 | 26 | 8 |
| 678 | 27 | 8 |
| 679 | 28 | 8 |
| 680 | 29 | 8 |
| 681 | 30 | 8 |
| 682 | 31 | 8 |
| 683 | 32 | 8 |
| 684 | 33 | 8 |
| 685 | 34 | 8 |
| 686 | 35 | 8 |
| 687 | 36 | 8 |
| 688 | 37 | 8 |
| 689 | 38 | 8 |
| 690 | 39 | 8 |
| 691 | 40 | 8 |
| 692 | 41 | 8 |
| 693 | 42 | 8 |
| 694 | 43 | 8 |
| 695 | 44 | 8 |
| 696 | 45 | 8 |
| 697 | 46 | 8 |
| 698 | 47 | 8 |
| 699 | 48 | 8 |
| 700 | 49 | 8 |
| 701 | 50 | 8 |
| 702 | 51 | 8 |
| 703 | 52 | 8 |
| 704 | 53 | 8 |
| 705 | 54 | 8 |
| 706 | 55 | 8 |
| 707 | 56 | 8 |
| 708 | 57 | 8 |
| 709 | 58 | 8 |
| 710 | 59 | 8 |
| 711 | 60 | 8 |
| 712 | 61 | 8 |
| 713 | 62 | 8 |
| 714 | 63 | 8 |
| 715 | 64 | 8 |
| 716 | 65 | 8 |
| 717 | 66 | 8 |
| 718 | 67 | 8 |
| 719 | 68 | 8 |
| 720 | 69 | 8 |
| 721 | 70 | 8 |
| 722 | 71 | 8 |
| 723 | 72 | 8 |
| 724 | 73 | 8 |
| 725 | 74 | 8 |
| 726 | 75 | 8 |
| 727 | 76 | 8 |
| 728 | 77 | 8 |
| 729 | 78 | 8 |
| 730 | 79 | 8 |
| 731 | 80 | 8 |
| 732 | 81 | 8 |
| 733 | 82 | 8 |
| 734 | 83 | 8 |
| 735 | 84 | 8 |
| 736 | 85 | 8 |
| 737 | 86 | 8 |
| 738 | 87 | 8 |
| 739 | 88 | 8 |
| 740 | 89 | 8 |
| 741 | 1 | 9 |
| 742 | 2 | 9 |
| 743 | 3 | 9 |
| 744 | 4 | 9 |
| 745 | 5 | 9 |
| 746 | 6 | 9 |
| 747 | 7 | 9 |
| 748 | 8 | 9 |
| 749 | 9 | 9 |
| 750 | 10 | 9 |
| 751 | 11 | 9 |
| 752 | 12 | 9 |
| 753 | 13 | 9 |
| 754 | 14 | 9 |
| 755 | 15 | 9 |
| 756 | 16 | 9 |
| 757 | 17 | 9 |
| 758 | 18 | 9 |
| 759 | 19 | 9 |
| 760 | 20 | 9 |
| 761 | 21 | 9 |
| 762 | 22 | 9 |
| 763 | 23 | 9 |
| 764 | 24 | 9 |
| 765 | 25 | 9 |
| 766 | 26 | 9 |
| 767 | 27 | 9 |
| 768 | 28 | 9 |
| 769 | 29 | 9 |
| 770 | 30 | 9 |
| 771 | 31 | 9 |
| 772 | 32 | 9 |
| 773 | 33 | 9 |
| 774 | 34 | 9 |
| 775 | 35 | 9 |
| 776 | 36 | 9 |
| 777 | 37 | 9 |
| 778 | 38 | 9 |
| 779 | 39 | 9 |
| 780 | 40 | 9 |
| 781 | 41 | 9 |
| 782 | 42 | 9 |
| 783 | 43 | 9 |
| 784 | 44 | 9 |
| 785 | 45 | 9 |
| 786 | 46 | 9 |
| 787 | 47 | 9 |
| 788 | 48 | 9 |
| 789 | 49 | 9 |
| 790 | 50 | 9 |
| 791 | 51 | 9 |
| 792 | 52 | 9 |
| 793 | 53 | 9 |
| 794 | 54 | 9 |
| 795 | 55 | 9 |
| 796 | 56 | 9 |
| 797 | 57 | 9 |
| 798 | 58 | 9 |
| 799 | 59 | 9 |
| 800 | 60 | 9 |
| 801 | 61 | 9 |
| 802 | 62 | 9 |
| 803 | 63 | 9 |
| 804 | 64 | 9 |
| 805 | 65 | 9 |
| 806 | 66 | 9 |
| 807 | 67 | 9 |
| 808 | 68 | 9 |
| 809 | 69 | 9 |
| 810 | 70 | 9 |
| 811 | 71 | 9 |
| 812 | 72 | 9 |
| 813 | 73 | 9 |
| 814 | 74 | 9 |
| 815 | 75 | 9 |
| 816 | 76 | 9 |
| 817 | 77 | 9 |
| 818 | 78 | 9 |
| 819 | 79 | 9 |
| 820 | 80 | 9 |
| 821 | 81 | 9 |
| 822 | 82 | 9 |
| 823 | 83 | 9 |
| 824 | 84 | 9 |
| 825 | 85 | 9 |
| 826 | 86 | 9 |
| 827 | 87 | 9 |
| 828 | 88 | 9 |
| 829 | 1 | 10 |
| 830 | 2 | 10 |
| 831 | 3 | 10 |
| 832 | 4 | 10 |
| 833 | 5 | 10 |
| 834 | 6 | 10 |
| 835 | 7 | 10 |
| 836 | 8 | 10 |
| 837 | 9 | 10 |
| 838 | 10 | 10 |
| 839 | 11 | 10 |
| 840 | 12 | 10 |
| 841 | 13 | 10 |
| 842 | 14 | 10 |
| 843 | 15 | 10 |
| 844 | 16 | 10 |
| 845 | 17 | 10 |
| 846 | 18 | 10 |
| 847 | 19 | 10 |
| 848 | 20 | 10 |
| 849 | 21 | 10 |
| 850 | 22 | 10 |
| 851 | 23 | 10 |
| 852 | 24 | 10 |
| 853 | 25 | 10 |
| 854 | 26 | 10 |
| 855 | 27 | 10 |
| 856 | 28 | 10 |
| 857 | 29 | 10 |
| 858 | 30 | 10 |
| 859 | 31 | 10 |
| 860 | 32 | 10 |
| 861 | 33 | 10 |
| 862 | 34 | 10 |
| 863 | 35 | 10 |
| 864 | 36 | 10 |
| 865 | 37 | 10 |
| 866 | 38 | 10 |
| 867 | 39 | 10 |
| 868 | 40 | 10 |
| 869 | 41 | 10 |
| 870 | 42 | 10 |
| 871 | 43 | 10 |
| 872 | 44 | 10 |
| 873 | 45 | 10 |
| 874 | 46 | 10 |
| 875 | 47 | 10 |
| 876 | 48 | 10 |
| 877 | 49 | 10 |
| 878 | 50 | 10 |
| 879 | 51 | 10 |
| 880 | 52 | 10 |
| 881 | 53 | 10 |
| 882 | 54 | 10 |
| 883 | 55 | 10 |
| 884 | 56 | 10 |
| 885 | 57 | 10 |
| 886 | 58 | 10 |
| 887 | 59 | 10 |
| 888 | 60 | 10 |
| 889 | 61 | 10 |
| 890 | 62 | 10 |
| 891 | 63 | 10 |
| 892 | 64 | 10 |
| 893 | 65 | 10 |
| 894 | 66 | 10 |
| 895 | 67 | 10 |
| 896 | 68 | 10 |
| 897 | 69 | 10 |
| 898 | 70 | 10 |
| 899 | 71 | 10 |
| 900 | 72 | 10 |
| 901 | 73 | 10 |
| 902 | 74 | 10 |
| 903 | 75 | 10 |
| 904 | 76 | 10 |
| 905 | 77 | 10 |
| 906 | 78 | 10 |
| 907 | 79 | 10 |
| 908 | 80 | 10 |
| 909 | 81 | 10 |
| 910 | 82 | 10 |
| 911 | 83 | 10 |
| 912 | 84 | 10 |
| 913 | 85 | 10 |
| 914 | 86 | 10 |
| 915 | 87 | 10 |
| 916 | 1 | 11 |
| 917 | 2 | 11 |
| 918 | 3 | 11 |
| 919 | 4 | 11 |
| 920 | 5 | 11 |
| 921 | 6 | 11 |
| 922 | 7 | 11 |
| 923 | 8 | 11 |
| 924 | 9 | 11 |
| 925 | 10 | 11 |
| 926 | 11 | 11 |
| 927 | 12 | 11 |
| 928 | 13 | 11 |
| 929 | 14 | 11 |
| 930 | 15 | 11 |
| 931 | 16 | 11 |
| 932 | 17 | 11 |
| 933 | 18 | 11 |
| 934 | 19 | 11 |
| 935 | 20 | 11 |
| 936 | 21 | 11 |
| 937 | 22 | 11 |
| 938 | 23 | 11 |
| 939 | 24 | 11 |
| 940 | 25 | 11 |
| 941 | 26 | 11 |
| 942 | 27 | 11 |
| 943 | 28 | 11 |
| 944 | 29 | 11 |
| 945 | 30 | 11 |
| 946 | 31 | 11 |
| 947 | 32 | 11 |
| 948 | 33 | 11 |
| 949 | 34 | 11 |
| 950 | 35 | 11 |
| 951 | 36 | 11 |
| 952 | 37 | 11 |
| 953 | 38 | 11 |
| 954 | 39 | 11 |
| 955 | 40 | 11 |
| 956 | 41 | 11 |
| 957 | 42 | 11 |
| 958 | 43 | 11 |
| 959 | 44 | 11 |
| 960 | 45 | 11 |
| 961 | 46 | 11 |
| 962 | 47 | 11 |
| 963 | 48 | 11 |
| 964 | 49 | 11 |
| 965 | 50 | 11 |
| 966 | 51 | 11 |
| 967 | 52 | 11 |
| 968 | 53 | 11 |
| 969 | 54 | 11 |
| 970 | 55 | 11 |
| 971 | 56 | 11 |
| 972 | 57 | 11 |
| 973 | 58 | 11 |
| 974 | 59 | 11 |
| 975 | 60 | 11 |
| 976 | 61 | 11 |
| 977 | 62 | 11 |
| 978 | 63 | 11 |
| 979 | 64 | 11 |
| 980 | 65 | 11 |
| 981 | 66 | 11 |
| 982 | 67 | 11 |
| 983 | 68 | 11 |
| 984 | 69 | 11 |
| 985 | 70 | 11 |
| 986 | 71 | 11 |
| 987 | 72 | 11 |
| 988 | 73 | 11 |
| 989 | 74 | 11 |
| 990 | 75 | 11 |
| 991 | 76 | 11 |
| 992 | 77 | 11 |
| 993 | 78 | 11 |
| 994 | 79 | 11 |
| 995 | 80 | 11 |
| 996 | 81 | 11 |
| 997 | 82 | 11 |
| 998 | 83 | 11 |
| 999 | 84 | 11 |
| 1000 | 85 | 11 |
| 1001 | 86 | 11 |
| 1002 | 1 | 12 |
| 1003 | 2 | 12 |
| 1004 | 3 | 12 |
| 1005 | 4 | 12 |
| 1006 | 5 | 12 |
| 1007 | 6 | 12 |
| 1008 | 7 | 12 |
| 1009 | 8 | 12 |
| 1010 | 9 | 12 |
| 1011 | 10 | 12 |
| 1012 | 11 | 12 |
| 1013 | 12 | 12 |
| 1014 | 13 | 12 |
| 1015 | 14 | 12 |
| 1016 | 15 | 12 |
| 1017 | 16 | 12 |
| 1018 | 17 | 12 |
| 1019 | 18 | 12 |
| 1020 | 19 | 12 |
| 1021 | 20 | 12 |
| 1022 | 21 | 12 |
| 1023 | 22 | 12 |
| 1024 | 23 | 12 |
| 1025 | 24 | 12 |
| 1026 | 25 | 12 |
| 1027 | 26 | 12 |
| 1028 | 27 | 12 |
| 1029 | 28 | 12 |
| 1030 | 29 | 12 |
| 1031 | 30 | 12 |
| 1032 | 31 | 12 |
| 1033 | 32 | 12 |
| 1034 | 33 | 12 |
| 1035 | 34 | 12 |
| 1036 | 35 | 12 |
| 1037 | 36 | 12 |
| 1038 | 37 | 12 |
| 1039 | 38 | 12 |
| 1040 | 39 | 12 |
| 1041 | 40 | 12 |
| 1042 | 41 | 12 |
| 1043 | 42 | 12 |
| 1044 | 43 | 12 |
| 1045 | 44 | 12 |
| 1046 | 45 | 12 |
| 1047 | 46 | 12 |
| 1048 | 47 | 12 |
| 1049 | 48 | 12 |
| 1050 | 49 | 12 |
| 1051 | 50 | 12 |
| 1052 | 51 | 12 |
| 1053 | 52 | 12 |
| 1054 | 53 | 12 |
| 1055 | 54 | 12 |
| 1056 | 55 | 12 |
| 1057 | 56 | 12 |
| 1058 | 57 | 12 |
| 1059 | 58 | 12 |
| 1060 | 59 | 12 |
| 1061 | 60 | 12 |
| 1062 | 61 | 12 |
| 1063 | 62 | 12 |
| 1064 | 63 | 12 |
| 1065 | 64 | 12 |
| 1066 | 65 | 12 |
| 1067 | 66 | 12 |
| 1068 | 67 | 12 |
| 1069 | 68 | 12 |
| 1070 | 69 | 12 |
| 1071 | 70 | 12 |
| 1072 | 71 | 12 |
| 1073 | 72 | 12 |
| 1074 | 73 | 12 |
| 1075 | 74 | 12 |
| 1076 | 75 | 12 |
| 1077 | 76 | 12 |
| 1078 | 77 | 12 |
| 1079 | 78 | 12 |
| 1080 | 79 | 12 |
| 1081 | 80 | 12 |
| 1082 | 81 | 12 |
| 1083 | 82 | 12 |
| 1084 | 83 | 12 |
| 1085 | 84 | 12 |
| 1086 | 85 | 12 |
| 1087 | 1 | 13 |
| 1088 | 4 | 13 |
| 1089 | 7 | 13 |
| 1090 | 10 | 13 |
| 1091 | 13 | 13 |
| 1092 | 16 | 13 |
| 1093 | 19 | 13 |
| 1094 | 22 | 13 |
| 1095 | 25 | 13 |
| 1096 | 28 | 13 |
| 1097 | 31 | 13 |
| 1098 | 34 | 13 |
| 1099 | 37 | 13 |
| 1100 | 40 | 13 |
| 1101 | 43 | 13 |
| 1102 | 46 | 13 |
| 1103 | 49 | 13 |
| 1104 | 52 | 13 |
| 1105 | 55 | 13 |
| 1106 | 58 | 13 |
| 1107 | 61 | 13 |
| 1108 | 64 | 13 |
| 1109 | 67 | 13 |
| 1110 | 70 | 13 |
| 1111 | 73 | 13 |
| 1112 | 76 | 13 |
| 1113 | 79 | 13 |
| 1114 | 82 | 13 |
| 1115 | 1 | 14 |
| 1116 | 4 | 14 |
| 1117 | 7 | 14 |
| 1118 | 10 | 14 |
| 1119 | 13 | 14 |
| 1120 | 16 | 14 |
| 1121 | 19 | 14 |
| 1122 | 22 | 14 |
| 1123 | 25 | 14 |
| 1124 | 28 | 14 |
| 1125 | 31 | 14 |
| 1126 | 34 | 14 |
| 1127 | 37 | 14 |
| 1128 | 40 | 14 |
| 1129 | 43 | 14 |
| 1130 | 46 | 14 |
| 1131 | 49 | 14 |
| 1132 | 52 | 14 |
| 1133 | 55 | 14 |
| 1134 | 58 | 14 |
| 1135 | 61 | 14 |
| 1136 | 64 | 14 |
| 1137 | 67 | 14 |
| 1138 | 70 | 14 |
| 1139 | 73 | 14 |
| 1140 | 76 | 14 |
| 1141 | 79 | 14 |
| 1142 | 82 | 14 |
| 1143 | 1 | 15 |
| 1144 | 4 | 15 |
| 1145 | 7 | 15 |
| 1146 | 10 | 15 |
| 1147 | 13 | 15 |
| 1148 | 16 | 15 |
| 1149 | 19 | 15 |
| 1150 | 22 | 15 |
| 1151 | 25 | 15 |
| 1152 | 28 | 15 |
| 1153 | 31 | 15 |
| 1154 | 34 | 15 |
| 1155 | 37 | 15 |
| 1156 | 40 | 15 |
| 1157 | 43 | 15 |
| 1158 | 46 | 15 |
| 1159 | 49 | 15 |
| 1160 | 52 | 15 |
| 1161 | 55 | 15 |
| 1162 | 58 | 15 |
| 1163 | 61 | 15 |
| 1164 | 64 | 15 |
| 1165 | 67 | 15 |
| 1166 | 70 | 15 |
| 1167 | 73 | 15 |
| 1168 | 76 | 15 |
| 1169 | 79 | 15 |
| 1170 | 82 | 15 |
| 1171 | 1 | 16 |
| 1172 | 4 | 16 |
| 1173 | 7 | 16 |
| 1174 | 10 | 16 |
| 1175 | 13 | 16 |
| 1176 | 16 | 16 |
| 1177 | 19 | 16 |
| 1178 | 22 | 16 |
| 1179 | 25 | 16 |
| 1180 | 28 | 16 |
| 1181 | 31 | 16 |
| 1182 | 34 | 16 |
| 1183 | 37 | 16 |
| 1184 | 40 | 16 |
| 1185 | 43 | 16 |
| 1186 | 46 | 16 |
| 1187 | 49 | 16 |
| 1188 | 52 | 16 |
| 1189 | 55 | 16 |
| 1190 | 58 | 16 |
| 1191 | 61 | 16 |
| 1192 | 64 | 16 |
| 1193 | 67 | 16 |
| 1194 | 70 | 16 |
| 1195 | 73 | 16 |
| 1196 | 76 | 16 |
| 1197 | 79 | 16 |
| 1198 | 1 | 17 |
| 1199 | 4 | 17 |
| 1200 | 7 | 17 |
| 1201 | 10 | 17 |
| 1202 | 13 | 17 |
| 1203 | 16 | 17 |
| 1204 | 19 | 17 |
| 1205 | 22 | 17 |
| 1206 | 25 | 17 |
| 1207 | 28 | 17 |
| 1208 | 31 | 17 |
| 1209 | 34 | 17 |
| 1210 | 37 | 17 |
| 1211 | 40 | 17 |
| 1212 | 43 | 17 |
| 1213 | 46 | 17 |
| 1214 | 49 | 17 |
| 1215 | 52 | 17 |
| 1216 | 55 | 17 |
| 1217 | 58 | 17 |
| 1218 | 61 | 17 |
| 1219 | 64 | 17 |
| 1220 | 67 | 17 |
| 1221 | 70 | 17 |
| 1222 | 73 | 17 |
| 1223 | 76 | 17 |
| 1224 | 79 | 17 |
| 1225 | 1 | 18 |
| 1226 | 4 | 18 |
| 1227 | 7 | 18 |
| 1228 | 10 | 18 |
| 1229 | 13 | 18 |
| 1230 | 16 | 18 |
| 1231 | 19 | 18 |
| 1232 | 22 | 18 |
| 1233 | 25 | 18 |
| 1234 | 28 | 18 |
| 1235 | 31 | 18 |
| 1236 | 34 | 18 |
| 1237 | 37 | 18 |
| 1238 | 40 | 18 |
| 1239 | 43 | 18 |
| 1240 | 46 | 18 |
| 1241 | 49 | 18 |
| 1242 | 52 | 18 |
| 1243 | 55 | 18 |
| 1244 | 58 | 18 |
| 1245 | 61 | 18 |
| 1246 | 64 | 18 |
| 1247 | 67 | 18 |
| 1248 | 70 | 18 |
| 1249 | 73 | 18 |
| 1250 | 76 | 18 |
| 1251 | 79 | 18 |
| 1252 | 1 | 19 |
| 1253 | 4 | 19 |
| 1254 | 7 | 19 |
| 1255 | 10 | 19 |
| 1256 | 13 | 19 |
| 1257 | 16 | 19 |
| 1258 | 19 | 19 |
| 1259 | 22 | 19 |
| 1260 | 25 | 19 |
| 1261 | 28 | 19 |
| 1262 | 31 | 19 |
| 1263 | 34 | 19 |
| 1264 | 37 | 19 |
| 1265 | 40 | 19 |
| 1266 | 43 | 19 |
| 1267 | 46 | 19 |
| 1268 | 49 | 19 |
| 1269 | 52 | 19 |
| 1270 | 55 | 19 |
| 1271 | 58 | 19 |
| 1272 | 61 | 19 |
| 1273 | 64 | 19 |
| 1274 | 67 | 19 |
| 1275 | 70 | 19 |
| 1276 | 73 | 19 |
| 1277 | 76 | 19 |
| 1278 | 1 | 20 |
| 1279 | 4 | 20 |
| 1280 | 7 | 20 |
| 1281 | 10 | 20 |
| 1282 | 13 | 20 |
| 1283 | 16 | 20 |
| 1284 | 19 | 20 |
| 1285 | 22 | 20 |
| 1286 | 25 | 20 |
| 1287 | 28 | 20 |
| 1288 | 31 | 20 |
| 1289 | 34 | 20 |
| 1290 | 37 | 20 |
| 1291 | 40 | 20 |
| 1292 | 43 | 20 |
| 1293 | 46 | 20 |
| 1294 | 49 | 20 |
| 1295 | 52 | 20 |
| 1296 | 55 | 20 |
| 1297 | 58 | 20 |
| 1298 | 61 | 20 |
| 1299 | 64 | 20 |
| 1300 | 67 | 20 |
| 1301 | 70 | 20 |
| 1302 | 73 | 20 |
| 1303 | 76 | 20 |
| 1304 | 1 | 21 |
| 1305 | 4 | 21 |
| 1306 | 7 | 21 |
| 1307 | 10 | 21 |
| 1308 | 13 | 21 |
| 1309 | 16 | 21 |
| 1310 | 19 | 21 |
| 1311 | 22 | 21 |
| 1312 | 25 | 21 |
| 1313 | 28 | 21 |
| 1314 | 31 | 21 |
| 1315 | 34 | 21 |
| 1316 | 37 | 21 |
| 1317 | 40 | 21 |
| 1318 | 43 | 21 |
| 1319 | 46 | 21 |
| 1320 | 49 | 21 |
| 1321 | 52 | 21 |
| 1322 | 55 | 21 |
| 1323 | 58 | 21 |
| 1324 | 61 | 21 |
| 1325 | 64 | 21 |
| 1326 | 67 | 21 |
| 1327 | 70 | 21 |
| 1328 | 73 | 21 |
| 1329 | 76 | 21 |
| 1330 | 1 | 22 |
| 1331 | 4 | 22 |
| 1332 | 7 | 22 |
| 1333 | 10 | 22 |
| 1334 | 13 | 22 |
| 1335 | 16 | 22 |
| 1336 | 19 | 22 |
| 1337 | 22 | 22 |
| 1338 | 25 | 22 |
| 1339 | 28 | 22 |
| 1340 | 31 | 22 |
| 1341 | 34 | 22 |
| 1342 | 37 | 22 |
| 1343 | 40 | 22 |
| 1344 | 43 | 22 |
| 1345 | 46 | 22 |
| 1346 | 49 | 22 |
| 1347 | 52 | 22 |
| 1348 | 55 | 22 |
| 1349 | 58 | 22 |
| 1350 | 61 | 22 |
| 1351 | 64 | 22 |
| 1352 | 67 | 22 |
| 1353 | 70 | 22 |
| 1354 | 73 | 22 |
| 1355 | 1 | 23 |
| 1356 | 4 | 23 |
| 1357 | 7 | 23 |
| 1358 | 10 | 23 |
| 1359 | 13 | 23 |
| 1360 | 16 | 23 |
| 1361 | 19 | 23 |
| 1362 | 22 | 23 |
| 1363 | 25 | 23 |
| 1364 | 28 | 23 |
| 1365 | 31 | 23 |
| 1366 | 34 | 23 |
| 1367 | 37 | 23 |
| 1368 | 40 | 23 |
| 1369 | 43 | 23 |
| 1370 | 46 | 23 |
| 1371 | 49 | 23 |
| 1372 | 52 | 23 |
| 1373 | 55 | 23 |
| 1374 | 58 | 23 |
| 1375 | 61 | 23 |
| 1376 | 64 | 23 |
| 1377 | 67 | 23 |
| 1378 | 70 | 23 |
| 1379 | 73 | 23 |
| 1380 | 1 | 24 |
| 1381 | 4 | 24 |
| 1382 | 7 | 24 |
| 1383 | 10 | 24 |
| 1384 | 13 | 24 |
| 1385 | 16 | 24 |
| 1386 | 19 | 24 |
| 1387 | 22 | 24 |
| 1388 | 25 | 24 |
| 1389 | 28 | 24 |
| 1390 | 31 | 24 |
| 1391 | 34 | 24 |
| 1392 | 37 | 24 |
| 1393 | 40 | 24 |
| 1394 | 43 | 24 |
| 1395 | 46 | 24 |
| 1396 | 49 | 24 |
| 1397 | 52 | 24 |
| 1398 | 55 | 24 |
| 1399 | 58 | 24 |
| 1400 | 61 | 24 |
| 1401 | 64 | 24 |
| 1402 | 67 | 24 |
| 1403 | 70 | 24 |
| 1404 | 73 | 24 |
| 1405 | 1 | 25 |
| 1406 | 5 | 25 |
| 1407 | 9 | 25 |
| 1408 | 13 | 25 |
| 1409 | 17 | 25 |
| 1410 | 21 | 25 |
| 1411 | 25 | 25 |
| 1412 | 29 | 25 |
| 1413 | 33 | 25 |
| 1414 | 37 | 25 |
| 1415 | 41 | 25 |
| 1416 | 45 | 25 |
| 1417 | 49 | 25 |
| 1418 | 53 | 25 |
| 1419 | 57 | 25 |
| 1420 | 61 | 25 |
| 1421 | 65 | 25 |
| 1422 | 69 | 25 |
| 1423 | 1 | 26 |
| 1424 | 5 | 26 |
| 1425 | 9 | 26 |
| 1426 | 13 | 26 |
| 1427 | 17 | 26 |
| 1428 | 21 | 26 |
| 1429 | 25 | 26 |
| 1430 | 29 | 26 |
| 1431 | 33 | 26 |
| 1432 | 37 | 26 |
| 1433 | 41 | 26 |
| 1434 | 45 | 26 |
| 1435 | 49 | 26 |
| 1436 | 53 | 26 |
| 1437 | 57 | 26 |
| 1438 | 61 | 26 |
| 1439 | 65 | 26 |
| 1440 | 69 | 26 |
| 1441 | 1 | 27 |
| 1442 | 5 | 27 |
| 1443 | 9 | 27 |
| 1444 | 13 | 27 |
| 1445 | 17 | 27 |
| 1446 | 21 | 27 |
| 1447 | 25 | 27 |
| 1448 | 29 | 27 |
| 1449 | 33 | 27 |
| 1450 | 37 | 27 |
| 1451 | 41 | 27 |
| 1452 | 45 | 27 |
| 1453 | 49 | 27 |
| 1454 | 53 | 27 |
| 1455 | 57 | 27 |
| 1456 | 61 | 27 |
| 1457 | 65 | 27 |
| 1458 | 69 | 27 |
| 1459 | 1 | 28 |
| 1460 | 5 | 28 |
| 1461 | 9 | 28 |
| 1462 | 13 | 28 |
| 1463 | 17 | 28 |
| 1464 | 21 | 28 |
| 1465 | 25 | 28 |
| 1466 | 29 | 28 |
| 1467 | 33 | 28 |
| 1468 | 37 | 28 |
| 1469 | 41 | 28 |
| 1470 | 45 | 28 |
| 1471 | 49 | 28 |
| 1472 | 53 | 28 |
| 1473 | 57 | 28 |
| 1474 | 61 | 28 |
| 1475 | 65 | 28 |
| 1476 | 69 | 28 |
| 1477 | 1 | 29 |
| 1478 | 5 | 29 |
| 1479 | 9 | 29 |
| 1480 | 13 | 29 |
| 1481 | 17 | 29 |
| 1482 | 21 | 29 |
| 1483 | 25 | 29 |
| 1484 | 29 | 29 |
| 1485 | 33 | 29 |
| 1486 | 37 | 29 |
| 1487 | 41 | 29 |
| 1488 | 45 | 29 |
| 1489 | 49 | 29 |
| 1490 | 53 | 29 |
| 1491 | 57 | 29 |
| 1492 | 61 | 29 |
| 1493 | 65 | 29 |
| 1494 | 1 | 30 |
| 1495 | 5 | 30 |
| 1496 | 9 | 30 |
| 1497 | 13 | 30 |
| 1498 | 17 | 30 |
| 1499 | 21 | 30 |
| 1500 | 25 | 30 |
| 1501 | 29 | 30 |
| 1502 | 33 | 30 |
| 1503 | 37 | 30 |
| 1504 | 41 | 30 |
| 1505 | 45 | 30 |
| 1506 | 49 | 30 |
| 1507 | 53 | 30 |
| 1508 | 57 | 30 |
| 1509 | 61 | 30 |
| 1510 | 65 | 30 |
| 1511 | 1 | 31 |
| 1512 | 5 | 31 |
| 1513 | 9 | 31 |
| 1514 | 13 | 31 |
| 1515 | 17 | 31 |
| 1516 | 21 | 31 |
| 1517 | 25 | 31 |
| 1518 | 29 | 31 |
| 1519 | 33 | 31 |
| 1520 | 37 | 31 |
| 1521 | 41 | 31 |
| 1522 | 45 | 31 |
| 1523 | 49 | 31 |
| 1524 | 53 | 31 |
| 1525 | 57 | 31 |
| 1526 | 61 | 31 |
| 1527 | 65 | 31 |
| 1528 | 1 | 32 |
| 1529 | 5 | 32 |
| 1530 | 9 | 32 |
| 1531 | 13 | 32 |
| 1532 | 17 | 32 |
| 1533 | 21 | 32 |
| 1534 | 25 | 32 |
| 1535 | 29 | 32 |
| 1536 | 33 | 32 |
| 1537 | 37 | 32 |
| 1538 | 41 | 32 |
| 1539 | 45 | 32 |
| 1540 | 49 | 32 |
| 1541 | 53 | 32 |
| 1542 | 57 | 32 |
| 1543 | 61 | 32 |
| 1544 | 65 | 32 |
| 1545 | 1 | 33 |
| 1546 | 5 | 33 |
| 1547 | 9 | 33 |
| 1548 | 13 | 33 |
| 1549 | 17 | 33 |
| 1550 | 21 | 33 |
| 1551 | 25 | 33 |
| 1552 | 29 | 33 |
| 1553 | 33 | 33 |
| 1554 | 37 | 33 |
| 1555 | 41 | 33 |
| 1556 | 45 | 33 |
| 1557 | 49 | 33 |
| 1558 | 53 | 33 |
| 1559 | 57 | 33 |
| 1560 | 61 | 33 |
| 1561 | 1 | 34 |
| 1562 | 5 | 34 |
| 1563 | 9 | 34 |
| 1564 | 13 | 34 |
| 1565 | 17 | 34 |
| 1566 | 21 | 34 |
| 1567 | 25 | 34 |
| 1568 | 29 | 34 |
| 1569 | 33 | 34 |
| 1570 | 37 | 34 |
| 1571 | 41 | 34 |
| 1572 | 45 | 34 |
| 1573 | 49 | 34 |
| 1574 | 53 | 34 |
| 1575 | 57 | 34 |
| 1576 | 61 | 34 |
| 1577 | 1 | 35 |
| 1578 | 5 | 35 |
| 1579 | 9 | 35 |
| 1580 | 13 | 35 |
| 1581 | 17 | 35 |
| 1582 | 21 | 35 |
| 1583 | 25 | 35 |
| 1584 | 29 | 35 |
| 1585 | 33 | 35 |
| 1586 | 37 | 35 |
| 1587 | 41 | 35 |
| 1588 | 45 | 35 |
| 1589 | 49 | 35 |
| 1590 | 53 | 35 |
| 1591 | 57 | 35 |
| 1592 | 61 | 35 |
| 1593 | 1 | 36 |
| 1594 | 5 | 36 |
| 1595 | 9 | 36 |
| 1596 | 13 | 36 |
| 1597 | 17 | 36 |
| 1598 | 21 | 36 |
| 1599 | 25 | 36 |
| 1600 | 29 | 36 |
| 1601 | 33 | 36 |
| 1602 | 37 | 36 |
| 1603 | 41 | 36 |
| 1604 | 45 | 36 |
| 1605 | 49 | 36 |
| 1606 | 53 | 36 |
| 1607 | 57 | 36 |
| 1608 | 61 | 36 |
| 1609 | 1 | 37 |
| 1610 | 5 | 37 |
| 1611 | 9 | 37 |
| 1612 | 13 | 37 |
| 1613 | 17 | 37 |
| 1614 | 21 | 37 |
| 1615 | 25 | 37 |
| 1616 | 29 | 37 |
| 1617 | 33 | 37 |
| 1618 | 37 | 37 |
| 1619 | 41 | 37 |
| 1620 | 45 | 37 |
| 1621 | 49 | 37 |
| 1622 | 53 | 37 |
| 1623 | 57 | 37 |
| 1624 | 1 | 38 |
| 1625 | 5 | 38 |
| 1626 | 9 | 38 |
| 1627 | 13 | 38 |
| 1628 | 17 | 38 |
| 1629 | 21 | 38 |
| 1630 | 25 | 38 |
| 1631 | 29 | 38 |
| 1632 | 33 | 38 |
| 1633 | 37 | 38 |
| 1634 | 41 | 38 |
| 1635 | 45 | 38 |
| 1636 | 49 | 38 |
| 1637 | 53 | 38 |
| 1638 | 57 | 38 |
| 1639 | 1 | 39 |
| 1640 | 5 | 39 |
| 1641 | 9 | 39 |
| 1642 | 13 | 39 |
| 1643 | 17 | 39 |
| 1644 | 21 | 39 |
| 1645 | 25 | 39 |
| 1646 | 29 | 39 |
| 1647 | 33 | 39 |
| 1648 | 37 | 39 |
| 1649 | 41 | 39 |
| 1650 | 45 | 39 |
| 1651 | 49 | 39 |
| 1652 | 53 | 39 |
| 1653 | 57 | 39 |
| 1654 | 1 | 40 |
| 1655 | 5 | 40 |
| 1656 | 9 | 40 |
| 1657 | 13 | 40 |
| 1658 | 17 | 40 |
| 1659 | 21 | 40 |
| 1660 | 25 | 40 |
| 1661 | 29 | 40 |
| 1662 | 33 | 40 |
| 1663 | 37 | 40 |
| 1664 | 41 | 40 |
| 1665 | 45 | 40 |
| 1666 | 49 | 40 |
| 1667 | 53 | 40 |
| 1668 | 57 | 40 |
| 1669 | 1 | 41 |
| 1670 | 5 | 41 |
| 1671 | 9 | 41 |
| 1672 | 13 | 41 |
| 1673 | 17 | 41 |
| 1674 | 21 | 41 |
| 1675 | 25 | 41 |
| 1676 | 29 | 41 |
| 1677 | 33 | 41 |
| 1678 | 37 | 41 |
| 1679 | 41 | 41 |
| 1680 | 45 | 41 |
| 1681 | 49 | 41 |
| 1682 | 53 | 41 |
| 1683 | 1 | 42 |
| 1684 | 5 | 42 |
| 1685 | 9 | 42 |
| 1686 | 13 | 42 |
| 1687 | 17 | 42 |
| 1688 | 21 | 42 |
| 1689 | 25 | 42 |
| 1690 | 29 | 42 |
| 1691 | 33 | 42 |
| 1692 | 37 | 42 |
| 1693 | 41 | 42 |
| 1694 | 45 | 42 |
| 1695 | 49 | 42 |
| 1696 | 53 | 42 |
| 1697 | 1 | 43 |
| 1698 | 5 | 43 |
| 1699 | 9 | 43 |
| 1700 | 13 | 43 |
| 1701 | 17 | 43 |
| 1702 | 21 | 43 |
| 1703 | 25 | 43 |
| 1704 | 29 | 43 |
| 1705 | 33 | 43 |
| 1706 | 37 | 43 |
| 1707 | 41 | 43 |
| 1708 | 45 | 43 |
| 1709 | 49 | 43 |
| 1710 | 53 | 43 |
| 1711 | 1 | 44 |
| 1712 | 5 | 44 |
| 1713 | 9 | 44 |
| 1714 | 13 | 44 |
| 1715 | 17 | 44 |
| 1716 | 21 | 44 |
| 1717 | 25 | 44 |
| 1718 | 29 | 44 |
| 1719 | 33 | 44 |
| 1720 | 37 | 44 |
| 1721 | 41 | 44 |
| 1722 | 45 | 44 |
| 1723 | 49 | 44 |
| 1724 | 53 | 44 |
| 1725 | 1 | 45 |
| 1726 | 5 | 45 |
| 1727 | 9 | 45 |
| 1728 | 13 | 45 |
| 1729 | 17 | 45 |
| 1730 | 21 | 45 |
| 1731 | 25 | 45 |
| 1732 | 29 | 45 |
| 1733 | 33 | 45 |
| 1734 | 37 | 45 |
| 1735 | 41 | 45 |
| 1736 | 45 | 45 |
| 1737 | 49 | 45 |
| 1738 | 1 | 46 |
| 1739 | 5 | 46 |
| 1740 | 9 | 46 |
| 1741 | 13 | 46 |
| 1742 | 17 | 46 |
| 1743 | 21 | 46 |
| 1744 | 25 | 46 |
| 1745 | 29 | 46 |
| 1746 | 33 | 46 |
| 1747 | 37 | 46 |
| 1748 | 41 | 46 |
| 1749 | 45 | 46 |
| 1750 | 49 | 46 |
| 1751 | 1 | 47 |
| 1752 | 5 | 47 |
| 1753 | 9 | 47 |
| 1754 | 13 | 47 |
| 1755 | 17 | 47 |
| 1756 | 21 | 47 |
| 1757 | 25 | 47 |
| 1758 | 29 | 47 |
| 1759 | 33 | 47 |
| 1760 | 37 | 47 |
| 1761 | 41 | 47 |
| 1762 | 45 | 47 |
| 1763 | 49 | 47 |
| 1764 | 1 | 48 |
| 1765 | 5 | 48 |
| 1766 | 9 | 48 |
| 1767 | 13 | 48 |
| 1768 | 17 | 48 |
| 1769 | 21 | 48 |
| 1770 | 25 | 48 |
| 1771 | 29 | 48 |
| 1772 | 33 | 48 |
| 1773 | 37 | 48 |
| 1774 | 41 | 48 |
| 1775 | 45 | 48 |
| 1776 | 49 | 48 |
| 1777 | 1 | 49 |
| 1778 | 5 | 49 |
| 1779 | 9 | 49 |
| 1780 | 13 | 49 |
| 1781 | 17 | 49 |
| 1782 | 21 | 49 |
| 1783 | 25 | 49 |
| 1784 | 29 | 49 |
| 1785 | 33 | 49 |
| 1786 | 37 | 49 |
| 1787 | 41 | 49 |
| 1788 | 45 | 49 |
| 1789 | 1 | 50 |
| 1790 | 5 | 50 |
| 1791 | 9 | 50 |
| 1792 | 13 | 50 |
| 1793 | 17 | 50 |
| 1794 | 21 | 50 |
| 1795 | 25 | 50 |
| 1796 | 29 | 50 |
| 1797 | 33 | 50 |
| 1798 | 37 | 50 |
| 1799 | 41 | 50 |
| 1800 | 45 | 50 |
| 1801 | 1 | 51 |
| 1802 | 5 | 51 |
| 1803 | 9 | 51 |
| 1804 | 13 | 51 |
| 1805 | 17 | 51 |
| 1806 | 21 | 51 |
| 1807 | 25 | 51 |
| 1808 | 29 | 51 |
| 1809 | 33 | 51 |
| 1810 | 37 | 51 |
| 1811 | 41 | 51 |
| 1812 | 45 | 51 |
| 1813 | 1 | 52 |
| 1814 | 5 | 52 |
| 1815 | 9 | 52 |
| 1816 | 13 | 52 |
| 1817 | 17 | 52 |
| 1818 | 21 | 52 |
| 1819 | 25 | 52 |
| 1820 | 29 | 52 |
| 1821 | 33 | 52 |
| 1822 | 37 | 52 |
| 1823 | 41 | 52 |
| 1824 | 45 | 52 |
| 1825 | 1 | 53 |
| 1826 | 5 | 53 |
| 1827 | 9 | 53 |
| 1828 | 13 | 53 |
| 1829 | 17 | 53 |
| 1830 | 21 | 53 |
| 1831 | 25 | 53 |
| 1832 | 29 | 53 |
| 1833 | 33 | 53 |
| 1834 | 37 | 53 |
| 1835 | 41 | 53 |
| 1836 | 1 | 54 |
| 1837 | 5 | 54 |
| 1838 | 9 | 54 |
| 1839 | 13 | 54 |
| 1840 | 17 | 54 |
| 1841 | 21 | 54 |
| 1842 | 25 | 54 |
| 1843 | 29 | 54 |
| 1844 | 33 | 54 |
| 1845 | 37 | 54 |
| 1846 | 41 | 54 |
| 1847 | 1 | 55 |
| 1848 | 5 | 55 |
| 1849 | 9 | 55 |
| 1850 | 13 | 55 |
| 1851 | 17 | 55 |
| 1852 | 21 | 55 |
| 1853 | 25 | 55 |
| 1854 | 29 | 55 |
| 1855 | 33 | 55 |
| 1856 | 37 | 55 |
| 1857 | 41 | 55 |
| 1858 | 1 | 56 |
| 1859 | 5 | 56 |
| 1860 | 9 | 56 |
| 1861 | 13 | 56 |
| 1862 | 17 | 56 |
| 1863 | 21 | 56 |
| 1864 | 25 | 56 |
| 1865 | 29 | 56 |
| 1866 | 33 | 56 |
| 1867 | 37 | 56 |
| 1868 | 41 | 56 |
| 1869 | 1 | 57 |
| 1870 | 5 | 57 |
| 1871 | 9 | 57 |
| 1872 | 13 | 57 |
| 1873 | 17 | 57 |
| 1874 | 21 | 57 |
| 1875 | 25 | 57 |
| 1876 | 29 | 57 |
| 1877 | 33 | 57 |
| 1878 | 37 | 57 |
| 1879 | 1 | 58 |
| 1880 | 5 | 58 |
| 1881 | 9 | 58 |
| 1882 | 13 | 58 |
| 1883 | 17 | 58 |
| 1884 | 21 | 58 |
| 1885 | 25 | 58 |
| 1886 | 29 | 58 |
| 1887 | 33 | 58 |
| 1888 | 37 | 58 |
| 1889 | 1 | 59 |
| 1890 | 5 | 59 |
| 1891 | 9 | 59 |
| 1892 | 13 | 59 |
| 1893 | 17 | 59 |
| 1894 | 21 | 59 |
| 1895 | 25 | 59 |
| 1896 | 29 | 59 |
| 1897 | 33 | 59 |
| 1898 | 37 | 59 |
| 1899 | 1 | 60 |
| 1900 | 5 | 60 |
| 1901 | 9 | 60 |
| 1902 | 13 | 60 |
| 1903 | 17 | 60 |
| 1904 | 21 | 60 |
| 1905 | 25 | 60 |
| 1906 | 29 | 60 |
| 1907 | 33 | 60 |
| 1908 | 37 | 60 |
| 1909 | 1 | 61 |
| 1910 | 5 | 61 |
| 1911 | 9 | 61 |
| 1912 | 13 | 61 |
| 1913 | 17 | 61 |
| 1914 | 21 | 61 |
| 1915 | 25 | 61 |
| 1916 | 29 | 61 |
| 1917 | 33 | 61 |
| 1918 | 1 | 62 |
| 1919 | 5 | 62 |
| 1920 | 9 | 62 |
| 1921 | 13 | 62 |
| 1922 | 17 | 62 |
| 1923 | 21 | 62 |
| 1924 | 25 | 62 |
| 1925 | 29 | 62 |
| 1926 | 33 | 62 |
| 1927 | 1 | 63 |
| 1928 | 5 | 63 |
| 1929 | 9 | 63 |
| 1930 | 13 | 63 |
| 1931 | 17 | 63 |
| 1932 | 21 | 63 |
| 1933 | 25 | 63 |
| 1934 | 29 | 63 |
| 1935 | 33 | 63 |
| 1936 | 1 | 64 |
| 1937 | 5 | 64 |
| 1938 | 9 | 64 |
| 1939 | 13 | 64 |
| 1940 | 17 | 64 |
| 1941 | 21 | 64 |
| 1942 | 25 | 64 |
| 1943 | 29 | 64 |
| 1944 | 33 | 64 |
| 1945 | 1 | 65 |
| 1946 | 5 | 65 |
| 1947 | 9 | 65 |
| 1948 | 13 | 65 |
| 1949 | 17 | 65 |
| 1950 | 21 | 65 |
| 1951 | 25 | 65 |
| 1952 | 29 | 65 |
| 1953 | 1 | 66 |
| 1954 | 5 | 66 |
| 1955 | 9 | 66 |
| 1956 | 13 | 66 |
| 1957 | 17 | 66 |
| 1958 | 21 | 66 |
| 1959 | 25 | 66 |
| 1960 | 29 | 66 |
| 1961 | 1 | 67 |
| 1962 | 5 | 67 |
| 1963 | 9 | 67 |
| 1964 | 13 | 67 |
| 1965 | 17 | 67 |
| 1966 | 21 | 67 |
| 1967 | 25 | 67 |
| 1968 | 29 | 67 |
| 1969 | 1 | 68 |
| 1970 | 5 | 68 |
| 1971 | 9 | 68 |
| 1972 | 13 | 68 |
| 1973 | 17 | 68 |
| 1974 | 21 | 68 |
| 1975 | 25 | 68 |
| 1976 | 29 | 68 |
| 1977 | 1 | 69 |
| 1978 | 5 | 69 |
| 1979 | 9 | 69 |
| 1980 | 13 | 69 |
| 1981 | 17 | 69 |
| 1982 | 21 | 69 |
| 1983 | 25 | 69 |
| 1984 | 1 | 70 |
| 1985 | 5 | 70 |
| 1986 | 9 | 70 |
| 1987 | 13 | 70 |
| 1988 | 17 | 70 |
| 1989 | 21 | 70 |
| 1990 | 25 | 70 |
| 1991 | 1 | 71 |
| 1992 | 5 | 71 |
| 1993 | 9 | 71 |
| 1994 | 13 | 71 |
| 1995 | 17 | 71 |
| 1996 | 21 | 71 |
| 1997 | 25 | 71 |
| 1998 | 1 | 72 |
| 1999 | 5 | 72 |
| 2000 | 9 | 72 |
| 2001 | 13 | 72 |
| 2002 | 17 | 72 |
| 2003 | 21 | 72 |
| 2004 | 25 | 72 |
| 2005 | 1 | 73 |
| 2006 | 5 | 73 |
| 2007 | 9 | 73 |
| 2008 | 13 | 73 |
| 2009 | 17 | 73 |
| 2010 | 21 | 73 |
| 2011 | 1 | 74 |
| 2012 | 5 | 74 |
| 2013 | 9 | 74 |
| 2014 | 13 | 74 |
| 2015 | 17 | 74 |
| 2016 | 21 | 74 |
| 2017 | 1 | 75 |
| 2018 | 5 | 75 |
| 2019 | 9 | 75 |
| 2020 | 13 | 75 |
| 2021 | 17 | 75 |
| 2022 | 21 | 75 |
| 2023 | 1 | 76 |
| 2024 | 5 | 76 |
| 2025 | 9 | 76 |
| 2026 | 13 | 76 |
| 2027 | 17 | 76 |
| 2028 | 21 | 76 |
| 2029 | 20 | 77 |
| 2030 | 19 | 78 |
| 2031 | 18 | 79 |
| 2032 | 17 | 80 |
| 2033 | 16 | 81 |
| 2034 | 15 | 82 |
| 2035 | 14 | 83 |
| 2036 | 13 | 84 |
| 2037 | 12 | 85 |
| 2038 | 11 | 86 |
| 2039 | 10 | 87 |
| 2040 | 9 | 88 |
| 2041 | 8 | 89 |
| 2042 | 7 | 90 |
| 2043 | 6 | 91 |
| 2044 | 5 | 92 |
| 2045 | 4 | 93 |
| 2046 | 3 | 94 |
| 2047 | 2 | 95 |
| 2048 | 1 | 96 |

Other variations of limiting the starting position or combinations of limiting the starting position and the size may be used to reduce the number of required signaling bits to indicate an index value, such as shown in Table 3.

An alternative method for resource allocation using A-MAP IEs relates to maximum allocation size (AS). The AS may be defined as follows:

AS=S*STC_rate*TTI_length (Equation 1)

where S is the number of LRUs derived from the RI field in the A-MAP IEs, STC_rate represents the space time coding (STC) rate allocated to the burst, and TTI_Length represents a length in subframes for the burst. The maximum AS value may be determined by multiple constraints. For example, a maximum value of AS may be defined as 192, and for a specific WTRU 102, a maximum allowable STC_rate is negotiated as a basic capability parameter during network entry. The maximum value of AS may not be larger than the multiple of the max allowable STC_rate for the MS and the number of LRUs in a subframe. Thus, the maximum value of AS and a given STC_rate and TTI_length may be used to derive the value range of S, in order to narrow down the valid combinations of size S and location L for the RI to be signaled in the A-MAP IEs.

An alternative method for allocation resources using A-MAP IE includes defining the size of the RI field in the assignment A-MAP IEs so that additional allocations may be specified. For example, a 12-bit RI field may be defined by using the 1-bit reserved field in the current downlink/uplink Basic Assignment A-MAP IEs. Alternatively, a 13-bit RI field may be defined by using the 1-bit reserved field and a 1-bit that is released from redefined other fields in the current Basic Assignment IEs (e.g., change the size of parameter fields of MIMO encodings from 5 bits to 4 bits).

With the 12-bit RI re-design, there is no impact on other information fields in the current downlink/uplink Basic assignment A-MAP IEs, as it uses the currently reserved 1-bit. A 12-bit RI field gives 4096 indexes to identify different combinations of allocation locations and sizes. The total number of all combinations of allocation locations and sizes in a 20 MHz system is 4656 (i.e., still 560 more than what a 12-bit RI field can specify). Any of the above methods, either alone or in combination, may be used to resolve this RI index shortage (e.g., eliminating those invalid location/size combinations by taking advantage of the frequency partitions and/or LRU types; and/or eliminating those invalid location/size combinations by considering the LRUs occupied by control channels; and/or reducing the number of assignable locations and/or assignable sizes).

For example, the RI field can be extended from 11 bits to 12 bits by using the currently reserved bit in the basic assignment A-MAP IEs, and the remaining reduction of RI field indexes can be achieved by disregarding the information of control channel resource occupancy to reduce the number of allocations that may be signaled in the assignment IEs. The control channel allocation reduction may be selectively used only when needed or may be applied to all cases. The 12-bit RI field from the current 11-bit RI plus 1 reserved bit may have no impact on any other info fields in the current assignment IEs. As previously described, the consideration of control channel resource occupancy reduces the number of allocations that may be signaled in the assignment A-MAP IEs. For example, in a 20 MHz channel bandwidth, if 6 LRUs are used for control channels in a subframe, then 4095 allocations may be needed to be signaled, which may be accommodated by the 12-bit RI field.

With the 13-bit RI re-design scheme, all the 4656 possible combinations of allocation locations and sizes may be identified. However, impact on other information fields in the current downlink/uplink Basic Assignment A-MAP IEs cannot be avoided, as one more bit may be released from another information field, in addition to using the currently reserved one bit. In order to minimize the impact on design of other information fields, one information field may be designed to release one bit. For example, the MIMO related information fields in the downlink/uplink Basic Assignment IEs may be candidates to be re-designed so that one bit may be released.

An alternative method for resource allocation using the A-MAP IEs, is to define the mapping according to discrete (i.e., non-contiguous) LRUs. Currently, the downlink/uplink basic assignment resource allocation consists of a set of contiguous LRUs in a subframe. However, allowing allocations with discrete LRUs may be desirable in some cases (e.g., diversity gain, and/or filling holes). Additionally, by allowing allocations with discrete LRUs, more valid allocations may become available to be signaled in the A-MAP IEs, thus making it even more challenging to design the A-MAP IEs with a very strict limitation on its size (e.g., 40 bits as in current specifications).

Several mechanisms may be used to support the allocations with discrete LRUs including: a) selectively choosing the allocations with discrete LRUs (i.e., not allowing all possible discrete ones); b) grouping LRUs (e.g., for subband LRUs), using the subband grouping mechanism (i.e., 4 LRUs per subband); c) using bitmaps to signal the inclusion of LRUs or groups of LRU in an allocation; or d) using the RI tables to define the allowed allocations, including allocations with contiguous LRUs and allocations with discrete LRUs. For example, when applying the constraint of the same LRU type and same frequency partition for allocations, the number of valid allocations may be significantly reduced, which may leave many of RI code points unused. In this case, the unused RI code points may be used to signal allocations with discrete LRUs.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method for resource allocation in assignment of information elements (IEs), the method comprising:
defining sets of selective starting locations (L) and allocation sizes (S) in combinations (L,S) for resource allocations, based on a predetermined total number of available logical resource units (LRUs) and valid resource allocations; and
defining a mapping of a resource index to each combination (L,S), wherein the location size S is a number of LRUs.

2. The method of claim 1, further comprising defining the valid resource allocations.

3. The method of claim 1, further comprising defining the mapping between the resource allocations and a resource index (RI) as an information field in resource assignment information elements (IEs).

4. The method of claim 2, wherein a valid resource allocation is an allocated set of LRUs (Logical Resource Units) contained within a same frequency partition.

5. The method of claim 2, wherein a valid resource allocation is an allocated set of LRUs are of the same type of LRUs, e.g., DRU (Distributed Resource Unit), NLRU (Miniband LRU), or SLRU (Subband LRU).

6. The method of claim 2, wherein a valid resource allocation is a set of allocated LRUs not occupied by pre-defined control channels.

7. The method of claim 1, wherein the starting locations L are selectively defined by fixed gaps between the (L,S) combinations.

8. A base station (BS) that allocations resources comprising:
a processor that:
defines sets of selective starting locations (L) and allocation sizes (S) in combinations (L,S) for resource allocations, based on a predetermined total number of available logical resource units (LRUs) and valid resource allocations; and
defines a mapping of a resource index to each combination (L,S), wherein the location size S is a number of LRUs.

9. The BS of claim 8, wherein the processor also defines the valid resource allocations.

10. The BS of claim 8, wherein the processor also defines a mapping between the resource allocations and a resource index (RI) as an information field in resource assignment information elements (IEs).

11. The BS of claim 9, wherein a valid resource allocation is an allocated set of LRUs (Logical Resource Units) contained within a same frequency partition.

12. The BS of claim 9, wherein a valid resource allocation is an allocated set of LRUs are of the same type of LRUs, e.g., DRU (Distributed Resource Unit), NLRU (Miniband LRU), or SLRU (Subband LRU).

13. The BS of claim 9, wherein a valid resource allocation is a set of allocated LRUs not occupied by pre-defined control channels.
